(19) United States
(12) Patent Application Publication
(10) Pub. No.: US 2026/0133354 A1
(43) Pub. Date: May 14, 2026

(54) STRUCTURED TRANSFER ARTICLES AND ARTICLES, AND METHODS OF MAKING STRUCTURED ARTICLES

(71) Applicant: 3M INNOVATIVE PROPERTIES COMPANY, St. Paul, MN (US)

(72) Inventors: Sean M. Sweetnam, Minneapolis, MN (US); David J. Rowe, Roseville, MN (US); Daniel M. Pierpont, North St. Paul, MN (US); Kevin D. Hagen, St. Paul, MN (US); Scott J. Jones, Circle Pines, MN (US); Kevin W. Gotrik, Hudson, WI (US); James A. Phipps, River Falls, WI (US)

(21) Appl. No.: 19/119,162

(22) PCT Filed: Nov. 15, 2023
(86) PCT No.: PCT/IB2023/061560

§ 371 Date: Apr. 8, 2025

Related U.S. Application Data
(60) Provisional application No. 63/434,404, filed on Dec. 21, 2022.
(60) Provisional application No. 63/492,798, filed on Mar. 29, 2023.
(60) Provisional application No. 63/583,321, filed on Sep. 18, 2023.

(51) Int. Cl. G02B 5/28; G02B 1/10; G02B 5/00; G02B 5/04; G02B 5/124; G02B 5/20

(52) U.S. Cl. CPC G02B 5/283; G02B 1/10; G02B 5/003; G02B 5/045; G02B 5/124; G02B 5/207; G02B 5/287

(57) ABSTRACT

Structured transfer articles and articles are provided. A transfer article includes a microstructured film including microstructures projecting therefrom. The transfer article further includes a metal or doped semiconductor release layer on the microstructures; a (co)polymer layer on the release layer opposite the microstructured film; and optionally a multilayer optical film on the (co) polymer layer opposite the release layer. The multilayer optical film is comprised of one or more alternating first and second inorganic optical layers collectively reflecting and absorbing light that is normally incident to the first major surface of the microstructured film, an average of at least 50 percent of incident ultraviolet light over at least a 30-nanometer wavelength reflection bandwidth in a wavelength range from 190 nanometers (nm) to 400 nm. An article includes at least a microstructured film; a multilayer optical film on the microstructures; and a (co)polymer layer disposed on a major surface of the multilayer optical film opposite the microstructured film. Methods of making articles are also provided, including obtaining a transfer article; depositing a polymeric or crosslinkable material on an exterior surface of the transfer article; curing the material; and removing the release layer.

### BACKGROUND

There is a class of telecommunications network with infrastructure provided by constellations of thousands of small satellites deployed in low earth orbit. These satellites require power via arrays of solar cells mounted to their frames and these solar arrays in turn require protection from the harsh environment of low earth orbit.

The devices typically operate at altitudes ranging from 20-2000 km, where the thin atmosphere absorbs little solar radiation. The high-altitude devices are thus exposed to the more intense AM0 solar spectrum and to a higher intensity of ultraviolet (UV) radiation, particularly UV-C radiation, than is present in the AM1.5 solar spectrum encountered in Earth terrestrial conditions.

### SUMMARY

In a first aspect, a transfer article is provided. The transfer article includes a microstructured film comprising a first major surface and an opposing second major surface, wherein the first major surface comprises a plurality of microstructures projecting therefrom. At least some of the plurality of microstructures each has a surface whose slope causes light that is normally incident to the first major surface of the microstructured film to intercept the first major surface or the surface of at least one other microstructure after reflection. The transfer article further includes a release layer disposed on the plurality of microstructures, wherein the release layer comprises a metal layer or a doped semiconductor layer; a (co)polymer layer disposed on a major surface of the release layer opposite the microstructured film; and a multilayer optical film disposed on a major surface of the (co)polymer layer opposite the release layer. The multilayer optical film is comprised of one or more alternating first and second inorganic optical layers collectively reflecting and absorbing light that is normally incident to the first major surface of the microstructured film, an average of at least 50, 60, 70, 80, 90, or 95 percent of incident ultraviolet light over at least a 30-nanometer wavelength reflection bandwidth in a wavelength range from 190 nanometers (nm) to 400 nm.

In a second aspect, another transfer article is provided. The transfer article includes a microstructured film comprising a first major surface and an opposing second major surface, wherein the first major surface comprises a plurality of microstructures projecting therefrom. At least some of the plurality of microstructures each has a surface whose slope causes light that is normally incident to the first major surface of the microstructured film to intercept the first major surface or the surface of at least one other microstructure after reflection. The transfer article further includes a release layer disposed on the plurality of microstructures, wherein the release layer comprises a metal layer or a doped semiconductor layer; and a (co)polymer layer disposed on a major surface of the release layer opposite the microstructured film, wherein the (co)polymer layer optionally further comprises an ultraviolet radiation absorber, a hindered amine light stabilizer, an antioxidant, or a combination thereof.

In a third aspect, an article is provided. The article includes a first microstructured film comprising a first major surface and an opposing second major surface, wherein the first major surface comprises a plurality of microstructures projecting therefrom. At least some of the plurality of microstructures each has a surface whose slope causes light that is normally incident to the first major surface of the first microstructured film to intercept the first major surface or the surface of at least one other microstructure after reflection. The article further includes a release layer disposed on the plurality of microstructures, wherein the release layer comprises a metal layer or a doped semiconductor layer; a (co)polymer layer disposed on a major surface of the release layer opposite the first microstructured film; a multilayer optical film disposed on a major surface of the (co)polymer layer opposite the release layer; and a second microstructured film adjacent to a major surface of the multilayer optical film opposite the (co)polymer layer. The second microstructured film comprises a first major surface and an opposing second major surface, wherein the first major surface comprises a plurality of microstructures projecting therefrom, wherein at least some of the plurality of microstructures each has a surface whose slope causes light that is normally incident to the first major surface of the second microstructured film to intercept the first major surface or the surface of at least one other microstructure after reflection. The multilayer optical film is comprised of one or more alternating first and second inorganic optical layers collectively reflecting and absorbing light that is normally incident to the first major surface of the second microstructured film, an average of at least 50, 60, 70, 80, 90, or 95 percent of incident ultraviolet light over at least a 30-nanometer wavelength reflection bandwidth in a wavelength range from 190 nanometers (nm) to 400 nm.

In a fourth aspect, another article is provided. The article includes a microstructured film comprising a first major surface and an opposing second major surface, wherein the first major surface comprises a plurality of microstructures projecting therefrom. At least some of the plurality of microstructures each has a surface whose slope causes light that is normally incident to the first major surface of the microstructured film to intercept the first major surface or the surface of at least one other microstructure after reflection. The article further includes a multilayer optical film disposed on the plurality of microstructures and a (co)polymer layer disposed on a major surface of the multilayer optical film opposite the microstructured film. The multilayer optical film is comprised of one or more alternating first and second inorganic optical layers collectively reflecting and absorbing light that is normally incident to the first major surface of the microstructured film, an average of at least 50, 60, 70, 80, 90, or 95 percent of incident ultraviolet light over at least a 30-nanometer wavelength reflection bandwidth in a wavelength range from 190 nanometers (nm) to 400 nm.

In a fifth aspect, a method of making an article is provided. The method includes obtaining a transfer article according to the first or second aspect; depositing a polymeric material or a crosslinkable material on an exterior major surface of the transfer article opposite the first microstructured film; curing the polymeric material or crosslinkable material to form a second microstructured film; and removing the release layer from the transfer article. The second microstructured film comprises a first major surface and an opposing second major surface, wherein the first major surface comprises a plurality of microstructures projecting therefrom, wherein at least some of the plurality of microstructures each has a surface whose slope causes light that is normally incident to the first major surface of the second microstructured film to intercept the first major surface or the surface of at least one other microstructure after reflection, and wherein the first major surface of the second microstructured film is adjacent to the multilayer optical film.

Broadband UV protection is of particular interest. Alternating layers of high and low index materials have been shown to provide UV rejection, but these are often limited to relatively narrow bands of reflection. UV absorbers, on the other hand, are often not able to provide sufficient absorption without thick layers, and many solutions are made with organic absorbers which do not always survive higher energy UVC light and atomic oxygen which are present in low earth orbit.

Sometimes the substrates preferred for vapor deposition of material layers that provide ultraviolet light shielding properties are not preferred for use in a space environment due to material property limitations such as coefficients of thermal expansion or radiation durability. Being able to decouple material properties of the substrate to be used in a space environment from the substrate used for the preparation of the article (e.g., using vapor coating deposition), would enable higher performance and durability combinations.

Transfer articles and articles according to at least certain embodiments of the present disclosure provide an inorganic based solution that combines the UV absorption of inorganic materials (e.g., titanium oxide or niobium oxide) with a reflection band created by alternating high and low index materials. This creates a broadband UV rejection filter that is durable to both UV and atomic oxygen. This technology could potentially replace the incumbent protective solution for solar cells in space, cover glass. The use of cover glass is expensive due to the fragile nature of glass slides, as well as the small size of glass slides that require a lot of trimming/laminating.

Various unexpected results and advantages are obtained in exemplary embodiments of the disclosure. One such advantage of exemplary embodiments of the present disclosure is that the combination of UV absorption and reflection in structured articles creates a broadband UV rejection filter made from durable inorganic materials that can survive in low earth orbit conditions. Additionally, the use of a microstructured film improves light capture of the article by minimizing light loss due to reflection, as compared to a planar film. Further, it was discovered that a microstructured article could be transferred to a different microstructured substrate. The ultraviolet light shielding layers can be sputter deposited or evaporated in a roll-to-roll process. As such, a further advantage of exemplary embodiments is to enable a high speed, roll-to-roll continuous production process for the structured transfer articles and structured articles of the present disclosure.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF THE DRAWINGS

The disclosure may be more completely understood in consideration of the following detailed description of various embodiments of the disclosure in connection with the accompanying figures, in which:

FIG. 1A is a perspective view of a Cartesian coordinate system of a surface that can be utilized to describe various microstructured surfaces;

FIG. 1B is a schematic cross-sectional view of a microstructured film for use in exemplary transfer articles and articles disclosed herein;

FIG. 1C is a schematic cross-sectional view of an exemplary structured transfer article according to various exemplary embodiments disclosed herein;

FIG. 1D is a schematic cross-sectional view of an exemplary structured article according to various exemplary embodiments disclosed herein;

FIG. 2 is a schematic cross-sectional view of exemplary structured transfer articles 10 and 20 and exemplary articles 30 and 40, according to various exemplary embodiments disclosed herein;

FIG. 3 is a perspective view of a microstructured surface comprising a linear array of prisms;

FIG. 4A is a perspective view of a microstructured surface comprising an array of cube corner elements;

FIG. 4B is a perspective view of a microstructured surface comprising an array of pyramid elements;

FIG. 5 is a perspective view of a microstructured surface comprising an array of cones;

FIG. 6 is a perspective view of a microstructured surface comprising a diffraction grating having a bias angle.

FIG. 7 is a perspective view of a microstructured surface comprising an array of inverted pyramids.

FIG. 8 is a scanning electron microscopy (SEM) image of a microstructured surface comprising an array of inverted cones.

In the drawings, like reference numerals indicate like elements. While the above-identified drawings, which may not be drawn to scale, set forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

For the following Glossary of defined terms, these definitions shall be applied for the entire application, unless a different definition is provided in the claims or elsewhere in the specification.

### Glossary

Certain terms are used throughout the description and the claims that, while for the most part are well known, may require some explanation. It should be understood that:

The term “fluoropolymer” refers to any organic polymer containing fluorine.

The term “nonfluorinated” means not containing fluorine.

The terms “(co)polymer” or “(co)polymers” includes homo (co)polymers and (co)polymers, as well as homo (co)polymers or (co)polymers that may be formed in a miscible blend, (e.g., by coextrusion or by reaction, including, (e.g., transesterification)). The term “(co)polymer” includes random, block and star (co)polymers.

As used herein, “adjacent” encompasses both in direct contact (e.g., directly adjacent) and having one or more intermediate layers present between the adjacent materials.

As used herein, “incident” with respect to light refers to the light falling on or striking a material.

The term “crosslinked” (co)polymer refers to a (co)polymer whose (co)polymer chains are joined together by covalent chemical bonds, usually via crosslinking molecules or groups, to form a network (co)polymer. A crosslinked (co)polymer is generally characterized by insolubility but may be swellable in the presence of an appropriate solvent.

The term “cure” encompasses cooling and/or solidifying as well as a process that causes a chemical change, (e.g., crosslinking or other reaction that creates a covalent bond to solidify a multilayer film layer or increase its viscosity.

The term “cured (co)polymer” includes both crosslinked and uncrosslinked (co)polymers.

The term “metal” includes a pure metal or a metal alloy.

The term “film” or “layer” refers to a single stratum within a multilayer film.

The term “substrate” encompasses films and layers, including microstructured films/layers.

The term “(meth)acryl” or “(meth)acrylate” with respect to a monomer, oligomer, (co)polymer or compound means a vinyl-functional alkyl ester formed as the reaction product of an alcohol with an acrylic or a methacrylic acid.

The term “optically clear” refers to an article in which there is no visibly noticeable distortion, haze or flaws as detected by the naked eye at a distance of about 1 meter, preferably about 0.5 meters.

The term “optical thickness” when used with respect to a layer refers to the physical thickness of the layer times its in-plane index of refraction.

The term “vapor coating” or “vapor depositing” means applying a coating to a substrate surface from a vapor phase, for example, by evaporating and subsequently depositing onto the substrate surface a precursor material to the coating or the coating material itself. Exemplary vapor coating processes include, for example, physical vapor deposition (PVD), chemical vapor deposition (CVD), and combinations thereof.

By using terms of orientation such as “atop”, “on”, “over,” “covering”, “uppermost”, “underlying” and the like for the location of various elements in the disclosed coated articles, we refer to the relative position of an element with respect to a horizontally-disposed, upwardly-facing substrate. However, unless otherwise indicated, it is not intended that the substrate or articles should have any particular orientation in space during or after manufacture, or in interpreting the claims.

As used herein, “radiation” refers to electromagnetic radiation unless otherwise specified.

As used herein, “scattering” with respect to wavelengths of light refers to causing the light to depart from a straight path and travel in different directions with different intensities.

As used herein, “reflectance” is the measure of the proportion of light or other radiation striking a surface at normal incidence which is reflected off it. Reflectivity typically varies with wavelength and is reported as the percent of incident light that is reflected from a surface (0 percent—no reflected light, 100—all light reflected). Reflectivity and reflectance are used interchangeably herein.

As used herein, “reflective” and “reflectivity” refer to the property of reflecting light or radiation, especially reflectance as measured independently of the thickness of a material.

As used herein, “average reflectance” refers to reflectance averaged over a specified wavelength range.

As used herein, “absorption” refers to a material converting the energy of light radiation to internal energy.

As used herein, “absorb” with respect to wavelengths of light encompasses both absorption and scattering, as scattered light also eventually gets absorbed. Absorbance can be measured with methods described in ASTM E903-12 “Standard Test Method for Solar Absorptance, Reflectance, and Transmittance of Materials Using Integrating Spheres”. Absorbance measurements described herein were made by making transmission measurements as previously described and then calculating absorbance using Equation 1.

As used herein, the term “absorbance” with respect to a quantitative measurement refers to the base 10 logarithm of a ratio of incident radiant power to transmitted radiant power through a material. The ratio may be described as the radiant flux received by the material divided by the radiant flux transmitted by the material. Absorbance (A) may be calculated based on internal transmittance (T) according to Equation 1:

$$A = - {log}_{10} T \qquad ( 1 )$$

Emissivity can be measured using infrared imaging radiometers with methods described in ASTM E1933-14 (2018) “Standard Practice for Measuring and Compensating for Emissivity Using Infrared Imaging Radiometers.” According to Kirchhoff's law of thermal radiation, absorbance correlates with emittance. Absorbance, absorptivity, emissivity, and emittance are used interchangeably herein for the same purpose of emitting infrared energy to the atmosphere. Absorb and emit are also used interchangeably herein.

As used herein, the terms “transmittance” and “transmission” refer to the ratio of total transmission of a layer of a material compared to that received by the material, which may account for the effects of absorption, scattering, reflection, etc. Transmittance (T) may range from 0 to 1 or be expressed as a percentage (T %).

As used herein, “transparent” refers to a material (e.g., film or layer) that absorbs less than 20% of light having wavelengths between 350 nm and 2500 nm.

As used herein, “bandwidth” refers to a width of a contiguous band of wavelengths.

As used herein, the term “flexible” refers to being capable of being bent around a roll core with a radius of curvature of up to 7.6 centimeters (cm) (3 inches), in some embodiments up to 6.4 cm (2.5 inches), 5 cm (2 inches), 3.8 cm (1.5 inch), or 2.5 cm (1 inch). In some embodiments, the flexible assembly can be bent around a radius of curvature of at least 0.635 cm (¼ inch), 1.3 cm (½ inch) or 1.9 cm (¾ inch).

The terms “about” or “approximately” with reference to a numerical value or a shape means+/−five percent of the numerical value or property or characteristic, but expressly includes the exact numerical value.

The term “substantially” with reference to a property or characteristic means that the property or characteristic is exhibited to a greater extent than the opposite of that property or characteristic is exhibited. For example, a substrate that is “substantially” transparent refers to a substrate that transmits more radiation (e.g., visible light) than it fails to transmit (e.g., absorbs and reflects). Thus, a substrate that transmits more than 50% of the visible light incident upon its surface is substantially transparent, but a substrate that transmits 50% or less of the visible light incident upon its surface is not substantially transparent.

As used in this specification and the appended embodiments, the singular forms “a”, “an”, and “the” include plural referents unless the content clearly dictates otherwise. Thus, for example, reference to fine fibers containing “a compound” includes a mixture of two or more compounds. As used in this specification and the appended embodiments, the term “or” is generally employed in its sense including “and/or” unless the content clearly dictates otherwise.

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

By definition, the total weight percentages of all ingredients in a composition equals 100 weight percent.

Various exemplary embodiments of the disclosure will now be described. Exemplary embodiments of the present disclosure may take on various modifications and alterations without departing from the spirit and scope of the present disclosure. Accordingly, it is to be understood that the embodiments of the present disclosure are not to be limited to the following described exemplary embodiments but is to be controlled by the limitations set forth in the claims and any equivalents thereof.

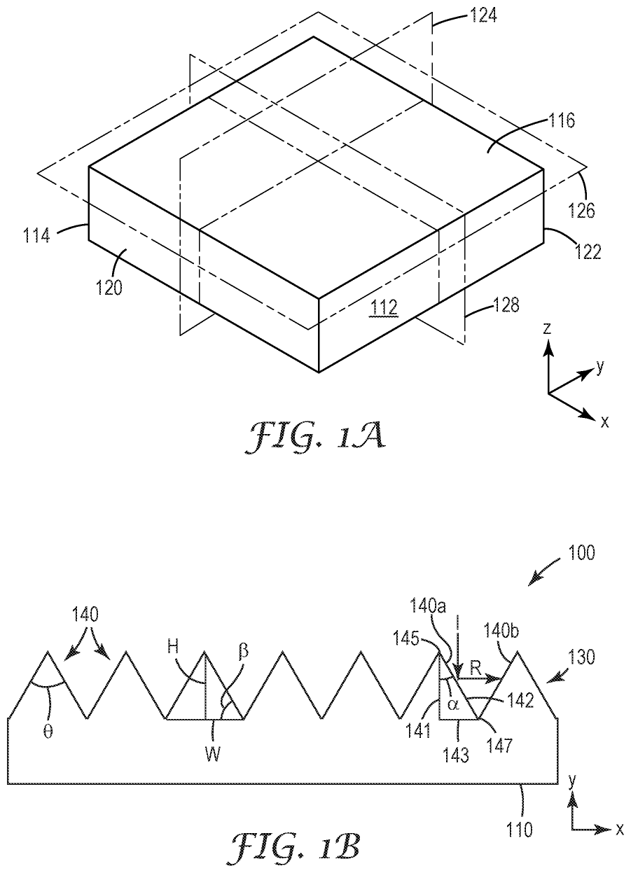

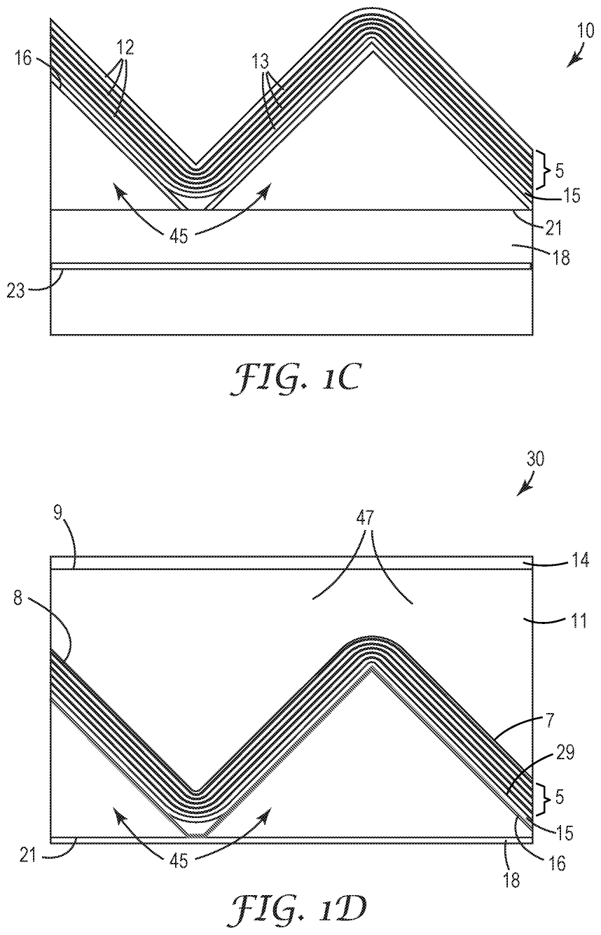

With reference to FIG. 1A, a microstructured surface can be characterized in three-dimensional space by superimposing a Cartesian coordinate system onto its structure. A first reference plane 124 is centered between major surfaces 112 and 114. First reference plane 124, referred to as the y-z plane, has the x-axis as its normal vector. A second reference plane 126, referred to as the x-y plane, extends substantially coplanar with surface 116 and has the z-axis as its normal vector. A third reference plane 128, referred to as the x-z plane, is centered between first end surface 120 and second end surface 122 and has the y-axis as its normal vector.

In some embodiments, the microstructured surfaces are three-dimensional on a macroscale. However, on a microscale (e.g., surface area that includes at least two adjacent microstructures with a valley or channel disposed between the microstructures) the base layer/base member can be considered planar with respect to the microstructures. The width and length of the microstructures are in the x-y plane and the height of the microstructures is in the z-direction. Further, the base layer is parallel to the x-y plane and orthogonal to the z-plane.

### Transfer Articles

In a first aspect, a transfer article is provided. The transfer article comprises:
a microstructured film comprising a first major surface and an opposing second major surface, wherein the first major surface comprises a plurality of microstructures projecting therefrom, wherein at least some of the plurality of microstructures each has a surface whose slope causes light that is normally incident to the first major surface of the microstructured film to intercept the first major surface or the surface of at least one other microstructure after reflection;
a release layer disposed on the plurality of microstructures, wherein the release layer comprises a metal layer or a doped semiconductor layer;
a (co)polymer layer disposed on a major surface of the release layer opposite the microstructured film; and
a multilayer optical film disposed on a major surface of the (co)polymer layer opposite the release layer, wherein the multilayer optical film is comprised of one or more alternating first and second inorganic optical layers collectively reflecting and absorbing light that is normally incident to the first major surface of the microstructured film, an average of at least 50, 60, 70, 80, 90, or 95 percent of incident ultraviolet light over at least a 30-nanometer wavelength reflection bandwidth in a wavelength range from 190 nanometers (nm) to 400 nm.

In a second aspect, another transfer article is provided. The transfer article comprises:
a microstructured film comprising a first major surface and an opposing second major surface, wherein the first major surface comprises a plurality of microstructures projecting therefrom, wherein at least some of the plurality of microstructures each has a surface whose slope causes light that is normally incident to the first major surface of the microstructured film to intercept the first major surface or the surface of at least one other microstructure after reflection;
a release layer disposed on the plurality of microstructures, wherein the release layer comprises a metal layer or a doped semiconductor layer; and
a (co)polymer layer disposed on a major surface of the release layer opposite the microstructured film, wherein the (co)polymer layer further comprises an ultraviolet radiation absorber, a hindered amine light stabilizer, an antioxidant, or a combination thereof.

The disclosure below relates to both the first and second aspects.

Referring again to FIG. 1A, by “light normally incident to the first major surface of the microstructured film” is meant light that strikes the first major surface 116 of the microstructured film orthogonal to the reference plane 126 (and parallel to the reference plane 124).

Referring now to FIG. 1B, a schematic cross-sectional view is provided of a microstructured film 100 comprising a plurality of microstructures 140 suitable for use in exemplary transfer articles and articles of the present disclosure. By “a microstructure that has a surface whose slope causes light that is normally incident to the first major surface of the microstructured film to intercept the first major surface or the surface of at least one other microstructure after reflection” is meant that incident light (“I”) that strikes a surface of a microstructure 140a normal to the first major surface 130 of the microstructured film 100, and the microstructure 140a has a slope 142 that causes reflected light (“R”) to intercept either the first major surface of the microstructured film (not shown) or the surface of another microstructure 140b. In this case, the valley (e.g., bottom) 147 between two adjacent microstructures 140a and 140b could be the portion of a first major surface that the reflected light intercepts if it does not intercept a surface of the microstructure 140b. Per the discussion above with respect to FIG. 1A, the first major surface 130 of the microstructured film 100 is considered parallel to a second major surface 110 of the microstructured film 100. The slope (e.g., sloped surface) 142 of the microstructure 140a is the height 141 of the microstructure 140a divided by the width 143 between the peak (e.g., high end of the sloped surface) 145 and the bottom (e.g., low end of the sloped surface) 147 of the microstructure 140a. Another way to determine slope is using the following formula:

$$m = \frac{Δ y}{Δ x} = tan β$$

wherein m is the slope, Δy is the height of the microstructure, Δx is the width between the peak and the bottom of the microstructure, and angle β is the angle of incline between the sloped surface of the microstructure and the bottom of the microstructure (e.g., as shown in FIG. 1B). For microstructures having a rounded peak, using the tangent of the angle of incline β may be a preferable way to determine the slope. An angle alpha (α) can be drawn between the slope 142 and the height 141 of the peak 145. In some cases, the angle α is 45 degrees or less, 40 degrees, 35 degrees, 30 degrees, 25 degrees, 20 degrees, 15 degrees, or 10 degrees or less.

FIG. 1C is a schematic cross-sectional view of a portion of an exemplary transfer article 10 according to at least some exemplary embodiments disclosed herein. The structured transfer article 10 includes a microstructured film 18 having a first major surface 21 and an opposing second major surface 23. The first major surface 21 comprises a plurality of microstructures 45 projecting therefrom. The transfer article 10 comprises a release layer 16 positioned on the plurality of microstructures 45. The release layer 16 will be described in more detail below. The transfer article 10 further comprises a (co)polymer layer 15 disposed on a major surface of the release layer 16 opposite the microstructured film 18 and a multilayer optical film 5 disposed on a major surface of the (co)polymer layer 15 opposite the release layer 16. The multilayer optical film 5 comprises alternating first inorganic optical layers 12 and second inorganic optical layers 13.

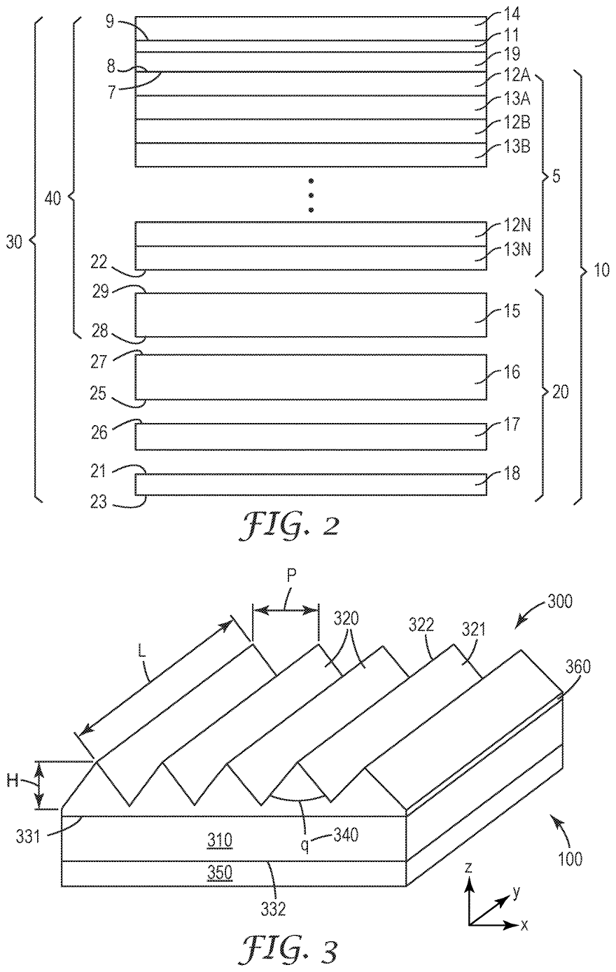

Referring now to FIG. 2, the present disclosure describes structured transfer articles 10 and 20. Both transfer articles 10 and 20 include a microstructured film 18 having a first major surface 21, a second major surface 23; a release layer 16 positioned on the first major surface 21 (e.g., on a plurality of microstructures of the microstructured film); and a (co)polymer layer 15 disposed on a major surface 27 of the release layer 16 opposite the microstructured film 18. It is noted that for simplicity in this figure, the schematic depiction of the various features does not show any microstructures. Optionally, the (co)polymer layer 15 is a first (co)polymer layer and the transfer article (10 or 20) further comprises a second (co)polymer layer 17 disposed between the microstructured film 18 and the release layer 16.

The transfer article 10 also comprises a multilayer optical film 5 positioned on a major surface 29 of the (e.g., first) (co)polymer layer 15.

The multilayer optical film 20 comprises one or more alternating first inorganic optical layers 12 (A-N) and second inorganic optical layers 13 (A-N).

### Microstructured Films

As mentioned above, a microstructured film comprises a first major surface and an opposing second major surface, wherein the first major surface comprises a plurality of microstructures projecting therefrom, wherein at least some of the plurality of microstructures each has a surface whose slope causes light that is normally incident to the first major surface of the microstructured film to intercept the first major surface or the surface of at least one other microstructure after reflection. As such, various different shapes of microstructures are suitable. For example, in some cases, the microstructures have a shape that is a prism, a pyramid, an inverted pyramid, a diffraction grating, an inverted cone, or a conc. Such shapes will be described in further detail below. Additionally, the inverse of any of these shapes are also suitable. Any number of facets of a three-dimensional shape may be present (e.g., any of a 4-sided pyramid, a 5-sided pyramid, a 6-sided pyramid, etc., would be suitable.).

In select embodiments, each of the microstructures has the same size and shape, which tends to assist in achieving consistent optical performance of the multilayer optical film deposited on the microstructures across the surface of the structured article. In select embodiments, the surfaces whose slope causes light that is normally incident to the first major surface of the microstructured film to intercept the first major surface or the surface of at least one other microstructure after reflection, each have the same slope. In such cases, the microstructures do not necessarily have to have the same size or shape, just the same slope.

Optionally, at least some of the microstructures have a shape with a triangular cross-section, such as the microstructures 140 and 40 in FIGS. 1B and 1C, respectively. While not required, in some cases, at least some of the microstructures 140 comprise at least one angled sidewall (e.g., 142) that has a peak 145 that comes to a point. Advantageously, it was discovered that it is possible to form the multilayer optical film on microstructures that have peaks that come to a point (e.g., that are not rounded at the peak) without having “pinholes” due to inadequate deposition of the multilayer optical film on the points of the peaks.

In some cases, as depicted in FIG. 1B, at least some of the microstructures 140 comprise at least one angled sidewall (e.g., 142) having a peak angle (e.g., apex angle) theta (θ) of 90 degrees or less, 85 degrees, 80 degrees, 75 degrees, 70 degrees, 65 degrees, 60 degrees, 55 degrees, 50 degrees, or 45 degrees or less; and 5 degrees or greater, 7 degrees, 10 degrees, 12 degrees, 15 degrees, 20 degrees, 25 degrees, 30 degrees, 35 degrees, 40 degrees, 45 degrees, or 50 degrees or greater. As used herein, the “peak angle” refers to the angle between opposing sides of a microstructure at the vertex of the microstructure.

Optionally, the plurality of microstructures 140 may have an aspect ratio of height H to (total) width W (i.e., H:W) of no more than 10:1, 9:1, 8:1, 7:1, 6:1, 5:1, 4:1, 3:1, 2:1, or no more than 1:1; and at least 1:2.

Typically, the microstructures each have a height of 0.5 micrometers or greater, 1 micrometer, 2 micrometers, 3 micrometers, 4 micrometers, 5 micrometers, 6 micrometers, 7 micrometers, 8 micrometers, 9 micrometers, 10 micrometers, 12 micrometers, 15 micrometers, 17 micrometers, 20 micrometers, 25 micrometers, 30 micrometers, 35 micrometers, 40 micrometers, 45 micrometers, 50 micrometers, 60 micrometers, 70 micrometers, 80 micrometers, 90 micrometers, 100 micrometers, 110 micrometers, 120 micrometers, 150 micrometers, 175 micrometers, 200 micrometers, 225 micrometers, or 250 micrometers or greater; and 500 micrometers or less, 475 micrometers, 450 micrometers, 425 micrometers, 400 micrometers, 375 micrometers, 350 micrometers, 325 micrometers, 300 micrometers, 275 micrometers, 250 micrometers, 225 micrometers, 200 micrometers, 175 micrometers, 150 micrometers, 125 micrometers, 100 micrometers, 75 micrometers, 50 micrometers, or 25 micrometers or less.

Referring to FIG. 3, in one embodiment, the first major surface 300 of a microstructured film 100 comprises a linear array of regular right prisms 320. Each prism has a first facet (e.g., sloped surface) 321 and a second facet 322. The prisms are illustrated as formed on a base member 310 that has a first planar surface 331 (parallel to reference plane 126) on which the prisms are formed and a second surface 332 that is substantially flat or planar and opposite first surface. It is envisioned that the second surface 332 could also be structured. By right prisms it is meant that the peak angle θ, 340, is typically about 90 degrees. However, this angle can range as described above. These peaks can be sharp (as shown) or rounded. The spacing between (e.g., prism) peaks may be characterized as pitch (“P”). In this embodiment, the pitch is also equal to the maximum width of the valley. The pitch may be greater than 1, 2, 3, 4, 5, 6, 7, 8, 9, or 10 microns ranging up to 250 microns. The length (“L”) of the (e.g., prism) microstructures is typically the largest dimension and can span the entire dimension of the microstructured surface. In select cases, linear prisms are oriented to extend across a width of a microstructured surface (e.g., cross-web) instead of down a length of a microstructured surface (e.g., down-web).

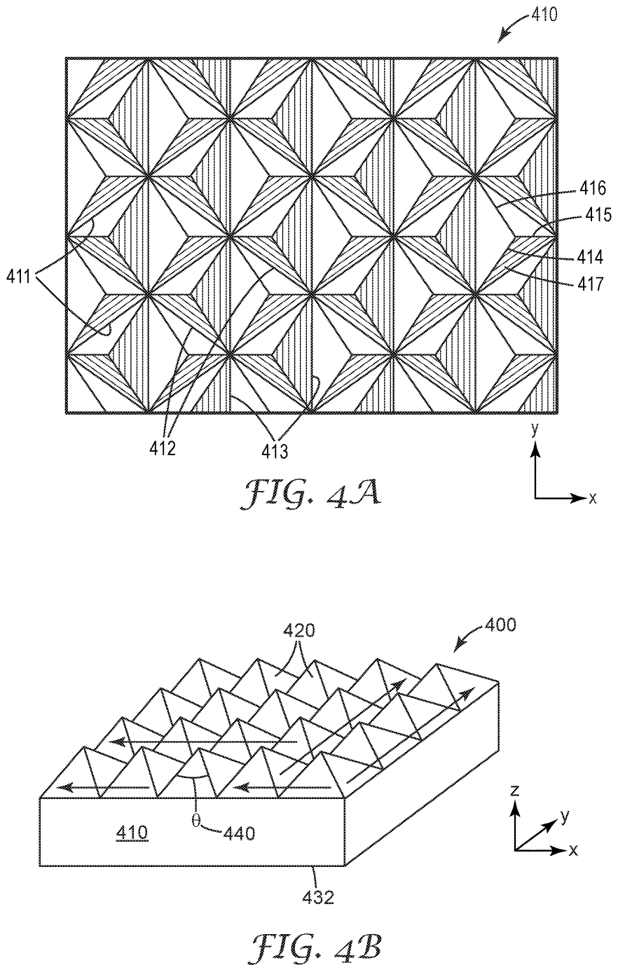

In another embodiment, the first major surface of the microstructured film may have the same surface shape as cube corner retroreflective sheeting. With reference to FIG. 4A, cube corner retroreflective sheeting typically comprises a thin transparent layer having a substantially planar surface and an opposing structured surface 410 comprising a plurality of cube corner elements 417. The microstructured surface 410 of FIG. 4A may be characterized as an array of cube corner elements 417 defined by three sets of parallel grooves (i.e., valleys) 411, 412, and 413; two sets of grooves (i.e., valleys) intersect each other at an angle greater than 60 degrees and a third set of grooves (valleys) intersects each of the other two sets at an angle less than 60 degrees to form an array of canted cube corner element matched pairs (see U.S. Pat. No. 4,588,258 (Hoopman)). The angles for the grooves are chosen such that the dihedral angle formed at the linear of intersection of the grooves, e.g., 414, 415, and 416 for representative cube-corner element 417 are about 90 degrees. In some embodiments, the triangular base has angle of at least 64, 65, 66, 67, 68, 69, or 70 degrees and the other angles are 55, 56, 57, or 58 degrees.

In another embodiment, depicted in FIG. 4B, the first major surface of the microstructured film 400 of FIG. 4B may be characterized as an array of pyramidal peak structures 420 defined by a first set of parallel grooves (i.e., valleys) in the y direction and a second set of parallel groves in the x direction. The base of the pyramidal peak structures is a polygon, typically a square or rectangle depending on the spacing of the grooves. The peak angle θ, 440, is typically about 90 degrees. However, this angle can range as described above.

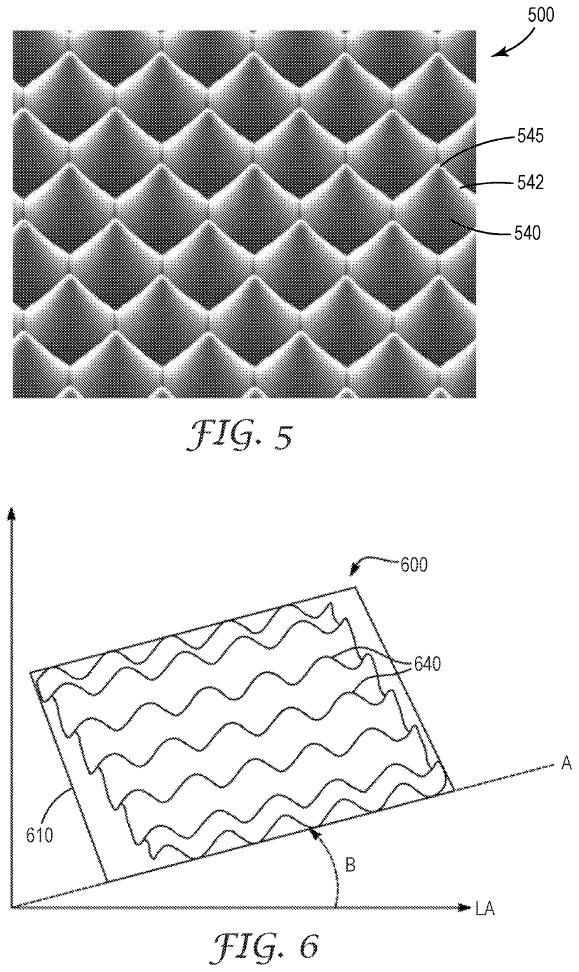

In some cases, the microstructures may have a shape of a cone. Referring to FIG. 5, a microstructured surface 500 of a microstructured film comprises an array of cones 540. Each microstructure of a cone shape typically has just one angled sidewall 542. The peak 545 of each cone can be pointed or rounded.

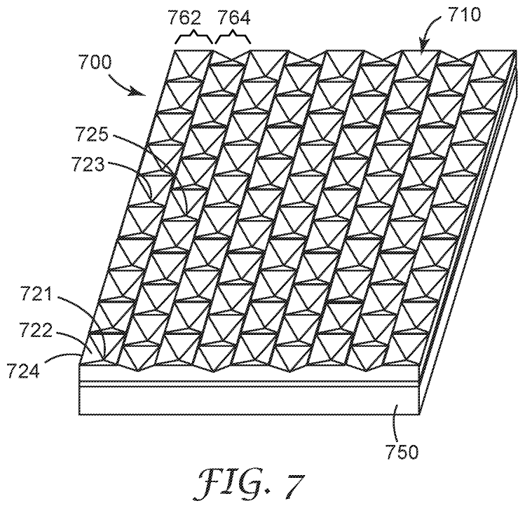

FIG. 6 depicts a schematic of a first major surface 600 of a microstructured film comprising a diffraction grating having a bias angle. A second major surface 610 of the microstructured film defines a longitudinal axis (“LA”) along its length and the plurality of microstructures 640 extends across the first major surface 600 to define a primary axis (“A”). The primary axis A and the longitudinal axis LA define a bias angle (“B”) therebetween. In some embodiments, the bias angle B is in a range of between about 0 degrees and about 90 degrees, such as between about 20 degrees and about 70 degrees.

In another embodiment, depicted in FIG. 7, the first major surface 710 of the microstructured film 700 may be characterized as an array of inverted pyramid structures 720. The structures 720 include facets 722 that meet in a valley (e.g., inverted peak) 721, and the opposing edge 724 of each facet together form a base of the pyramid structure 720 (i.e., at the outermost surface of the microstructured film 700). The base of the pyramid is a polygon, such as a square or rectangle. In this particular embodiment, adjacent rows of structures (e.g., end row 762 is adjacent to row 764) are offset from each other such that the bottoms of the valleys of adjacent structures (e.g., 723 in row 762 and an adjacent structure 725 in row 764) have different positions along the length of the rows (e.g., in a y-axis). It is expressly contemplated that such an offset configuration may be employed with any of the microstructures disclosed herein.

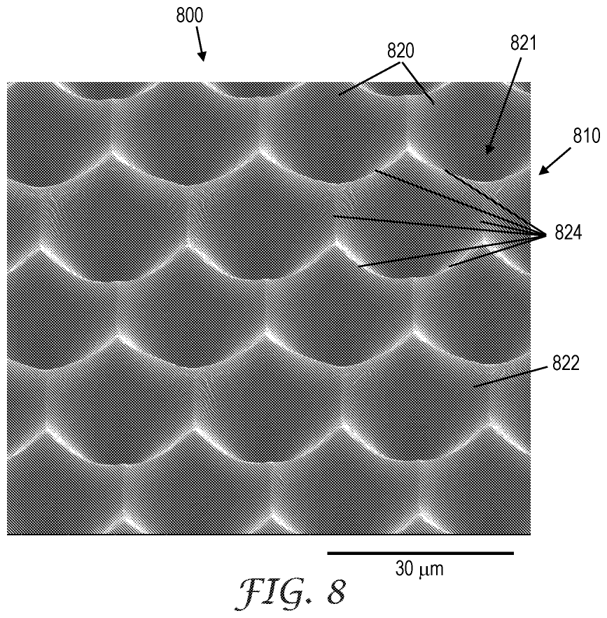

In another embodiment, depicted in FIG. 8, the first major surface 810 of the microstructured film 800 may be characterized as an array of inverted cones 820. The cone structures 820 include a curved wall 822 that ends in a valley (e.g., inverted peak) 821, and the edges 824 of the wall 822 opposite the valley 821 together form a base of the cone structure 820 (i.e., at the outermost surface of the microstructured film 800). The base of the cone can be a polygon, such as a hexagon, pentagon, square, rectangle, or triangle, or a circle, or an ellipse.

In some cases, the microstructured film is flexible (as defined in the Glossary). An advantage to employing a flexible microstructured film is avoiding the high cost of working with rigid glass, particularly small pieces of glass, which can break during handling and require significant labor due to the need to apply many small pieces of glass. Additionally, in some embodiments according to the present disclosure flexible microstructured film are used in roll-to-roll processing of manufacturing the structured articles and transfer articles. An advantage to roll-to-roll manufacturing is that the structured articles and transfer articles can be made in large area form factors. In some cases, the microstructured film (or the article/transfer article) has an area of at least 50 square centimeters, such as at least 60, 70, 80, 90, 100, 1,000, or at least 10,000 square centimeters.

In any of the foregoing embodiments, the microstructured film may be comprised of or consist of a polymeric material, such as a (co)polymer. In some exemplary embodiments, the microstructured film comprises polyethylene terephthalate (PET), a cured polysiloxane, a silicone thermoplastic polymer, a cured urethane, a thermoplastic urethane, a cured (meth)acrylate, a cured epoxy, a cured vinyl ether, a cured oxetane, a cured thiol-acrylate, a cured thiol-ene, a polypropylene, a polyethylene, polymethyl methacrylate (PMMA), coPMMA, a polyimide, a cyclic olefin copolymer, a cyclic olefin polymer, a polycarbonate, a polyethylene naphthalate (PEN), or a fluoropolymer (co)polymer comprising polymerized units derived from one or more monomers selected from tetrafluoroethylene, hexafluoropropylene, vinylidene fluoride, a perfluoroalkoxy alkylene, or a vinyl fluoride, or a combination thereof. Optionally, any of the cured polymeric materials mentioned above are crosslinked. Suitable polyimides are available under the trade name “KAPTON” from E. I. DuPont de Nemours, Wilmington, DE, of which “KAPTON CS100” is currently preferred. Suitable PMMA polymers include those available as CP71 and CP80 from Incos Acrylics, Inc., Wilmington. DE. One suitable crosslinkable silicone is available under the trade name “DOW CORNING 93-500 SPACE GRADE ENCAPSULANT KIT” from Dow Corning Corporation, Midland, MI. One suitable polycarbonate is available under the trade name “Makrofol”, from Bayer AG (Darmstadt. Germany). Suitable methyl methacrylate copolymers (CoPMMA) include, for instance, a CoPMMA made from 75 wt. % methylmethacrylate (MMA) monomers and 25 wt. % ethyl acrylate (EA) monomers, (available, for example, from Incos Acrylics. Inc. (London. England) under the trade designation “PERSPEX CP63” or Arkema Corp., (Philadelphia, PA) under the trade designation “ATOGLAS 510”), a CoPMMA formed with MMA comonomer units and n-butyl methacrylate (nBMA) comonomer units, or a blend of PMMA and poly(vinylidene fluoride) (PVDF). Suitable polyethylene naphthalate (PEN) polymers are available under the tradename “Teonex Q51” from DuPont Teijin, Chester, VA.

In certain exemplary embodiments, the fluorinated (co)polymer preferably comprises tetrafluoroethylene, hexafluoropropylene, vinylidene fluoride, a perfluoroalkoxy alkane, or a combination thereof. Suitable fluoropolymers are available under the trade name “TEFLON FEP100” from E. I. DuPont de Nemours. Wilmington, DE, or which “TEFLON FEP 100 500A is currently preferred. Suitable exemplary fluoropolymers also include copolymers of tetrafluorethylene, hexafluoropropylene, and vinylidene fluoride (THV) under the trade designations “DYNEON THV 220,” “DYNEON THV 221,” “DYNEON THV 230,” “DYNEON THV 2030,” “DYNEON THV 415”, “DYNEON THV 500”, “DYNEON THV 610”, and “DYNEON THV 815” from Dyncon LLC, Oakdale, MN.

In some applications, it may be useful to employ a low coefficient of thermal expansion (CTE) film, for instance when the article will be subjected to large variations in ambient temperature. Some exemplary low CTE polymers include for instance and without limitation, polyimide, heat stabilized PEN, and PET. Preferably, a low CTE material has a CTE of 80 parts per million per kelvin (ppm/K) or lower, 70 ppm/K, 60 ppm/K, 50 ppm/K, 40 ppm/K, 30 ppm/K, or even 25 ppm/K or less. The coefficient of thermal expansion has the general meaning as employed in the art, i.e., as determined using ASTM E831.

The smoothness and adhesion of layers to the microstructured film can be enhanced by appropriate optional pretreatment of the microstructured film or optional application of a priming layer. Methods for surface modification are known in the art. In one embodiment, a pretreatment regimen involves electrical discharge pretreatment of the substrate in the presence of a reactive or non-reactive atmosphere (e.g., plasma, glow discharge, corona discharge, dielectric barrier discharge or atmospheric pressure discharge), chemical pretreatment, or flame pretreatment. These pretreatments can help ensure that the surface of the microstructured film will be receptive to the subsequently applied layers. In one embodiment, the method can include plasma pretreatment. For organic surfaces, plasma pretreatments can include nitrogen or water vapor. Another pretreatment regimen involves coating the microstructured film with an inorganic or organic base coat layer optionally followed by further pretreatment using plasma or one of the other pretreatments described above.

Preferably, the microstructured film itself transmits an average of at least 70, 80, 90, or 95 percent of incident visible light in a wavelength range from greater than 400 nm to 700 nm.

### Release Layer

The release layer can include a metal layer. The metal layer may comprise at least one selected from the group consisting of individual metals, two or more metals as mixtures, inter-metallics or alloys, semi-metals or metalloids, metal oxides, metal and mixed metal oxides, metal and mixed metal fluorides, metal and mixed metal nitrides, metal and mixed metal carbides, metal and mixed metal carbonitrides, metal and mixed metal oxynitrides, metal and mixed metal borides, metal and mixed metal oxy borides, metal and mixed metal silicides, diamond-like carbon, diamond-like glass, graphene, and combinations thereof. In some embodiments, the metal layer may conveniently be formed of Al, Zr, Cu, NiCr, Ti, or Nb. In select embodiments, the release layer comprises a copper oxide. In select embodiments, the release layer comprises a silicon aluminum oxide. A suitable thickness range for the release layer is between 1 nm and 3000 nm.

Alternatively, the release layer can include a doped semiconductor layer. In some embodiments, the doped semiconductor layer may conveniently be formed of Si, B-doped Si, Al-doped Si, P-doped Si with thicknesses between 1 nm and 3000 nm. A particularly suitable doped semiconductor layer is Al-doped Si, wherein the Al compositional percentage is 10%. The release layer can typically be prepared by evaporation, reactive evaporation, sputtering, reactive sputtering, chemical vapor deposition, plasma enhanced chemical vapor deposition, and atomic layer deposition. Preferred methods include vacuum preparations such as sputtering and evaporation. In at least certain embodiments according to the present disclosure, the transfer article exhibits a release value between the release layer and the (e.g., first) (co)polymer layer from 2 to 50 grams per inch (g/in). Such a release value enables ready removal of the release layer when it is desired to transfer the article to another substrate.

### (Co)Polymer Layer(s)

At least one (co)polymer layer is included in exemplary transfer articles. Referring to FIG. 2, a (co)polymer layer 15 overlays the first major surface 27 of the release layer 16. Optionally the (co)polymer layer 15 is the first (co)polymer layer and the transfer article (10 or 20) further comprises a second (co)polymer layer 17 overlaying the first major surface 21 of the microstructured film 18. In select embodiments, a (co)polymer layer is substantially transparent.

Each (co)polymer layer comprises a (co)polymer independently selected from an olefinic (co)polymer, a (meth)acrylate (co)polymer, a urethane (co)polymer, a fluoropolymer, a silicone (co)polymer, or a combination thereof.

(Co)polymeric layers can be formed from a variety of organic materials or compounds using a variety of processes. The (co)polymeric layer may be crosslinked in situ after it is applied. In one embodiment, the (co)polymeric layer can be formed by flash evaporation, vapor deposition and (co)polymerization of a monomer using, for example, heat, plasma. UV radiation or an electron beam.

Exemplary monomers for use in such a method include volatilizable (meth)acrylate monomers. In a specific embodiment, volatilizable acrylate monomers are employed. Suitable (meth)acrylates will have a molecular weight that is sufficiently low to allow flash evaporation and sufficiently high to permit condensation on the substrate. The organic materials or compounds also can be vaporized using any methods like those described in PCT Publication No. WO 2022/243756 (Sweetnam et al.) for example the methods described with respect to vaporizing a metal alkoxide.

If desired, a (co)polymeric layer can alternatively be applied using conventional methods such as plasma deposition, solution coating, extrusion coating, roll coating (e.g., gravure roll coating), or spray coating (e.g., electrostatic spray coating), and if desired crosslinked or (co)polymerized, (e.g., as described above). The desired chemical composition and thickness of the layer will depend in part on the nature and desired purpose of the article. Coating efficiency can be improved by cooling the article. Exemplary organic compounds include esters, vinyl compounds, alcohols, carboxylic acids, acid anhydrides, acyl halides, thiols, amines and mixtures thereof. Non-limiting examples of esters include (meth)acrylates, which can be used alone or in combination with other multifunctional or monofunctional (meth)acrylates. Exemplary (meth)acrylates include hexanediol diacrylate, ethoxyethyl acrylate, phenoxyethyl acrylate, cyanoethyl (mono)acrylate, isobornyl acrylate, octadecyl acrylate, isodecyl acrylate, lauryl acrylate, beta-carboxyethyl acrylate, tetrahydrofurfuryl acrylate, dinitrile acrylate, pentafluorophenyl acrylate, nitrophenyl acrylate, 2-phenoxyethyl acrylate, 2,2,2-trifluoromethyl acrylate, diethylene glycol diacrylate, triethylene glycol diacrylate, tripropylene glycol diacrylate, tetraethylene glycol diacrylate, neopentyl glycol diacrylate, propoxylated neopentyl glycol diacrylate, polyethylene glycol diacrylate, tetracthylene glycol diacrylate, bisphenol A epoxy diacrylate, trimethylol propane triacrylate, tricyclodecane dimethanol diacrylate, hydroxyl pivalic acid neopentyl glycol diacrylate, ethoxylated trimethylol propane triacrylate, propylated trimethylol propane triacrylate, tris(2-hydroxyethyl)-isocyanurate triacrylate, pentaerythritol triacrylate, phenylthioethyl acrylate, naphthloxyethyl acrylate, IRR-214 cyclic diacrylate from UCB Chemicals, epoxy acrylate RDX80095 from Rad-Cure Corporation, the corresponding methacrylates of the acrylates listed above and mixtures thereof. Exemplary vinyl compounds include vinyl ethers, styrene, vinyl naphthylene and acrylonitrile.

Exemplary alcohols include hexanediol, naphthalenediol and hydroxyethylmethacrylate. Exemplary carboxylic acids include phthalic acid and terephthalic acid, (meth)acrylic acid). Exemplary acid anhydrides include phthalic anhydride and glutaric anhydride. Exemplary acyl halides include hexanedioyl dichloride, and succinyl dichloride. Exemplary thiols include ethyleneglycol-bisthioglycolate, and phenylthioethylacrylate. Exemplary amines include ethylene diamine and hexane 1,6-diamine.

Optionally, at least one (co)polymer layer further comprises an additive that is an ultraviolet radiation absorber, a hindered amine light stabilizer, an antioxidant, or a combination thereof. In particular, in transfer article(s) of select embodiments of the present disclosure, the (co)polymer layer(s) and/or the microstructured film(s) further comprise an additive that is an ultraviolet radiation absorber, a hindered amine light stabilizer, an antioxidant, or a combination thereof. UV absorbers (UVAs), Hindered Amine Light Stabilizers (HALs), and antioxidants can help prevention of photo-oxidation degradation of the (co)polymer layer. Suitable compounds include benzophenones, benzotriazoles, and triazines (e.g., benzotriazines). Exemplary UVAs for incorporation into the (co)polymer layer include those available under the trade designations “TINUVIN 1577” and “TINUVIN 1600,” from BASF Corporation, Florham Park, NJ. U.S. Pat. No. 9,670,300 (Olson et al.) and U.S. Pat. App. Pub. No. 2017/0198129 (Olson et al.) describe exemplary UVA oligomers that are compatible with PVDF fluoropolymers. Exemplary HALs for incorporation include those available under the trade designations “CHIMMASORB 944” and “TINUVIN 123,” from BASF Corporation. Typically, UVAs, HALs, and/or antioxidants are incorporated in the (co)polymer layer at a concentration of 1-10 wt. %.

In certain embodiments, a (co)polymer layer is preferably crosslinked.

In some exemplary embodiments, the outer (co)polymer layer comprises an olefinic (co)polymer selected from low density polyethylene, linear low density polyethylene, ethylene vinyl acetate, polyethylene methyl acrylate, polyethylene octene, polyethylene propylene, polyethylene butene, polyethylene maleic anhydride, polymethyl pentene, polyisobutene, polyisobutylene, polyethylene propylene diene, cyclic olefin (co)polymers, and blends thereof.

In certain exemplary embodiments, a (co)polymer layer further comprises an ultraviolet radiation absorber, a hindered amine light stabilizer, an antioxidant, or a combination thereof.

The ultraviolet radiation absorber is preferably selected from a benzotriazole compound, a benzophenone compound, a triazine compound, or a combination thereof. Presently preferred hindered amine light stabilizers are available from BASF U.S.A (Florham Park, NJ) under the trade name “TINUVIN”. The hindered amine light stabilizer is preferably selected from TINUVIN 123, TINUVIN 144, TINUVIN 292, or a combination thereof. Presently preferred anti-oxidants are available from BASF under the trade name “IRGANOX” and “IRGAFOS”. Suitable antioxidants for polyolefins are preferably selected from IRGANOX 1010, IRGANOX 1076, IRGAFOS 168, or a combination thereof.

### Multilayer Optical Films

Referring again to FIG. 2, the transfer article 10 includes a multilayer optical film 5 comprising one or more alternating first inorganic optical layers 12 (A-N) and second inorganic optical layers 13 (A-N) positioned on the first major surface 29 of the (co)polymer layer 15 as described further below.

Typically, the multilayer optical film has a thickness of 200 nm or greater, 250 nm, 300 nm, 350 nm, 400 nm, 500 nm, or 550 nm or greater; and 1500 nm or less, 1400 nm, 1300 nm, 1200 nm, 1100 nm, 1000 nm, 900 nm, 850 nm, 800 nm, 750 nm, 700 nm, 650 nm, or 600 nm or less, such as a thickness of 200 nm to 1500 nm.

### Inorganic Layers

In some cases, the first optical layer comprises at least one of niobium oxide, titanium oxide, silicon oxynitride, molybdenum oxide, tungsten oxide, silicon nitride, indium tin oxide, hafnium oxide, tantalum oxide, zirconium oxynitride, zirconium oxide, aluminum zinc oxide, or zinc oxide. Alloys of oxides may be suitable, as known to those skilled in the art. In some cases, the second optical layer comprises at least one of silicon oxide, silicon aluminum oxide, N type- or P type-doped silicon oxide, aluminum oxide, aluminum fluoride, magnesium fluoride, calcium fluoride, indium tin oxide, or zinc oxide. In select embodiments, the first optical layer comprises at least one of niobium oxide or titanium oxide, and the second optical layer comprises silicon aluminum oxide. When a photoactive inorganic material such as titanium oxide is employed, typically a non-photoactive material (e.g., silicon oxide, aluminum oxide, etc.) may be disposed between the photoactive inorganic material and any organic layers to minimize degradation of the organic layer. For instance, referring again to FIG. 2, a layer of a non-photoactive material could be an intermediate layer 19 located between the first optical layer 12A and a second microstructured film 11.

It was unexpectedly discovered that wavelengths of light in each of UVA, UVB, and UVC regions could be shielded from a microstructured film using just the combined reflectance and absorbance of a plurality of alternating first inorganic optical layers and second inorganic optical layers, typically while still maintaining an acceptable amount of transmission of visible light (e.g., at least 50% of incident visible light).

Optical thin film stack designs comprised of alternating thin layers of inorganic dielectric materials with refractive index contrast, are particularly suited for the multilayer optical film. In recent decades they have been used for applications in UV. Visible. NIR and IR spectral regions. Depending upon the spectral region of interest, there are specific materials suitable for that region. Also, for coating these materials, one of two forms of physical vapor deposition (PVD) are used: evaporation or sputtering. Evaporated coatings rely upon heating the coating material (evaporant) to a temperature at which it evaporates. This is followed by condensation of the vapor upon a substrate. For evaporated dielectric mirror coatings, the electron-beam deposition process is most commonly used. Sputtered coatings use energetic gas ions to bombard a material (“target”) surface, ejecting atoms which then condense on the nearby substrate. Depending upon which coating method is used, and the settings used for that method, thin film coating rate and structure-property relationships will be strongly influenced. Ideally, coating rates should be high enough to allow acceptable process throughput and film performance, characterized as dense, low stress, void free, non-optically absorbing coated layers.

The number of optical layers is selected to achieve the desired optical properties using the minimum number of layers for reasons of film thickness, flexibility and economy. One skilled in the art could extend such deposition techniques to include CVD, ALD, and other vapor depositions. Typically, the total number of layers is preferably 21 or less, 19, 17, 15, or 13 optical layers or less; and 3 optical layers or more, 5, 7, 9, or 11 optical layers or more, may be needed. In select embodiments, the multilayer optical film is formed of at least 1 first optical layer and 2 second optical layers.

The thickness of each of the first and second optical layers can vary substantially. For instance, in some cases each of the first optical layers and each of the second optical layers independently has a thickness of 5 nm or greater, 10 nm, 15 nm, 20 nm, 25 nm, 30 nm, 35 nm, 40 nm, 45 nm, 50 nm, 55 nm, 60 nm, 65 nm, or 70 nm or greater; and a thickness of 2000 nm or less, 500 nm, 145 nm, 140 nm, 135 nm, 130 nm, 125 nm, 120 nm, 115 nm, 110 nm, 105 nm, 100 nm, 95 nm, 90 nm, 85 nm, 80 nm, or 75 nm or less. In select embodiments, each of the first and second optical layers independently has a thickness of 20 nm to 400 nm.

Multilayer optical films described herein can be made using general processing techniques, such as those described in U.S. Pat. No. 6,783,349 (Neavin et al.), the entire disclosure of which is incorporated herein by reference in its entirety.

For manufacturing inorganic coatings, the electron beam process is best suited for coating discrete parts. Optionally, articles or transfer articles can be prepared in continuous roll-to-roll (R2R) fashion for larger articles. Though some chambers have demonstrated R2R film coating, the layer by layer coating sequence would still be necessary. For R2R sputtering of inorganic layers of articles or transfer articles, it is advantageous to use a sputtering system with multiple sources located around one, or perhaps two, coating drums. Here, for a thirteen layers optical stack design, a two, or even single, machine pass process, with alternating high and low refractive index layers coated sequentially, would be feasible. How many machine passes needed would be contingent upon machine design, cost, practicality of thirteen consecutive sources, and the like. Additionally, coating rates would need to be matched to a single film line speed.

The film roll transport initially starts at a pre-determined speed, and the sputter source power is ramped to full operating power, followed by introduction of the reactive gases and then achieving steady state condition. Depending upon the length of film to coat, the process continues until total footage is achieved. Here, as the sputter source is orthogonal to and wider than the film which is being coated, the uniformity of coating thickness is quite high. Upon reaching the desired length of coated film the reactive gases are set to zero and the target is sputtered to a pure metal surface state. The film direction is next reversed and a rotary pair of sputter targets has AC frequency (40 kHz) power applied in an argon sputtering atmosphere. Upon reaching steady state, oxygen reactive gas is introduced to provide transparency and low refractive index. At the pre-determined process setting and line speed the second layer is coated over the length which was coated for layer one. Again, as these sputter sources are also orthogonal to and wider than the film being coated, the uniformity of coating thickness is quite high. After reaching the desired length of coated film the reactive oxygen is removed and the target is sputtered in argon to a pure metal surface state. Layers three to five (or seven or nine, eleven or thirteen, etc.) depending upon optical targets, are coated in this sequence. Upon completion, the film roll is removed for post-processing.

The transfer article can be subjected to various post-treatments such as heat treatment. UV or vacuum UV (VUV) treatment, e-beam treatment, or plasma treatment. Heat treatment can be conducted by passing the article through an oven or directly heating the article in the coating apparatus, (e.g., using infrared heaters or heating directly on a drum. Heat treatment may for example be performed at temperatures from about 30° C. to about 200° C. about 35° C. to about 150° C. or about 40° C. to about 70° C.

### Articles

In a third aspect, an article is provided. The article comprises:
a first microstructured film comprising a first major surface and an opposing second major surface, wherein the first major surface comprises a plurality of microstructures projecting therefrom, wherein at least some of the plurality of microstructures each has a surface whose slope causes light that is normally incident to the first major surface of the first microstructured film to intercept the first major surface or the surface of at least one other microstructure after reflection;
a release layer disposed on the plurality of microstructures, wherein the release layer comprises a metal layer or a doped semiconductor layer;
a (co)polymer layer disposed on a major surface of the release layer opposite the first microstructured film;
a multilayer optical film disposed on a major surface of the (co)polymer layer opposite the release layer; and
a second microstructured film adjacent to a major surface of the multilayer optical film opposite the (co)polymer layer, wherein the second microstructured film comprises a first major surface and an opposing second major surface, wherein the first major surface comprises a plurality of microstructures projecting therefrom, wherein at least some of the plurality of microstructures each has a surface whose slope causes light that is normally incident to the first major surface of the second microstructured film to intercept the first major surface or the surface of at least one other microstructure after reflection;
wherein the multilayer optical film is comprised of one or more alternating first and second inorganic optical layers collectively reflecting and absorbing light that is normally incident to the first major surface of the second microstructured film, an average of at least 50, 60, 70, 80, 90, or 95 percent of incident ultraviolet light over at least a 30-nanometer wavelength reflection bandwidth in a wavelength range from 190 nanometers (nm) to 400 nm.

In a fourth aspect, another article is provided. The article comprises:
a microstructured film comprising a first major surface and an opposing second major surface, wherein the first major surface comprises a plurality of microstructures projecting therefrom, wherein at least some of the plurality of microstructures each has a surface whose slope causes light that is normally incident to the first major surface of the microstructured film to intercept the first major surface or the surface of at least one other microstructure after reflection;
a multilayer optical film disposed on the plurality of microstructures, wherein the multilayer optical film is comprised of one or more alternating first and second inorganic optical layers collectively reflecting and absorbing light that is normally incident to the first major surface of the microstructured film, an average of at least 50, 60, 70, 80, 90, or 95 percent of incident ultraviolet light over at least a 30-nanometer wavelength reflection bandwidth in a wavelength range from 190 nanometers (nm) to 400 nm; and a (co)polymer layer disposed on a major surface of the multilayer optical film opposite the microstructured film.

The below disclosure relates to both the third and fourth aspects.

Referring again to FIG. 2, an article 30 comprises a first microstructured film 18 comprising a first major surface 21 and an opposing second major surface 23, and a release layer 16 disposed on the first major surface 21 of the first microstructured film 18. The article 30 further comprises a (co)polymer layer 15 disposed on a major surface 27 of the release layer 16 opposite the first microstructured film 18 and a multilayer optical film 5 disposed on a major surface 29 of the (co)polymer layer 15 opposite the release layer 16. Additionally, the article 30 comprises a second microstructured film 11 adjacent to a major surface 7 of the multilayer optical film 5 opposite the (co)polymer layer 15. Optionally, the (co)polymer layer 15 is a first (co)polymer layer and the article 30 further comprises a second (co)polymer layer 17 disposed between the first microstructured film 18 and the release layer 16.

Referring now to FIG. 1D, an article 30 comprises a first microstructured film 18 comprising a first major surface 21, wherein the first major surface 21 comprises a plurality of microstructures 45 projecting therefrom, and a release layer 16 disposed on the microstructures 45. The article 30 further comprises a (co)polymer layer 15 disposed on the release layer 16 opposite the first microstructured film 18 and a multilayer optical film 5 disposed on a major surface 29 of the (co)polymer layer 15 opposite the release layer 16. Additionally, the article 30 comprises a second microstructured film 11 adjacent to a major surface 8 of the multilayer optical film 5 opposite the (co)polymer layer 15. The second microstructured film 11 comprises a first major surface 7 and an opposing second major surface 9, wherein the first major surface 7 comprises a plurality of microstructures 47 projecting therefrom, wherein at least some of the plurality of microstructures 47 each has a surface whose slope causes light that is normally incident to the first major surface 7 of the second microstructured film 11 to intercept the first major surface 7 or the surface of at least one other microstructure after reflection. In some cases, the second microstructured film 11 is directly adjacent to the multilayer optical film 5, while in other cases an intermediate layer (not shown) may be present between the two.

As can be seen in FIG. 1D, the microstructures 47 of the second microstructured film 11 have a shape that is the inverse of the microstructures 45 of the first microstructured film 18. In an end application use, the article will include the second microstructured film 11, thus the shape of the microstructures 45 of the first microstructured film 18 should be selected to be an inverse of the desired shape of the microstructures 47 of the second microstructured film 11.

In use, the article would be oriented opposite the orientation depicted in FIG. 1D such that incident light would reach the microstructures 47 of the first major surface 7 of the second microstructured film 11 before reaching the second opposing major surface 9 of the second microstructured film 11. Articles of the fourth aspect (i.e., articles having just one microstructured film), according to at least certain embodiments disclosed herein, transmit light that is normally incident to the first major surface of the second microstructured film, an average of at least 50, 60, 70, 80, 90, or 95 percent of normally incident visible light in a wavelength range from greater than 400 nm to 700 nm. Articles according to certain preferred embodiments of the present disclosure exhibit an average transmission of wavelengths between 400 nm and 700 nm through the article being reduced by less than 20%, 10%, 5%, or less than 1% after exposure to a dose of 425 megajoules per square meter (MJ/m²)).

In select embodiments, in use the outermost inorganic layer is a second inorganic optical layer (e.g., 13N in FIG. 2) and has a thickness of at least 70 nm. This has the effect of reducing the amount of light reflected off the outer surface of the article and increases the light transmitted between 400 nm and 700 nm, which is particularly useful when the article is used in solar applications, e.g., to allow visible light to reach the solar cells.

In select embodiments, in use at least one of the first optical layers nearest to the exterior of the article (e.g., 12N in FIG. 2) or nearest to the microstructured film (e.g., 12A in FIG. 2) has a thickness of at most 95%, 90%, 85%, or at most 80% of the other first optical layers. This has the effect of reducing the amount of light reflected off the outer surface of the article between 400 nm and 700 nm, which is particularly useful when the article is used in solar applications, to allow visible light to reach the solar cells.

The alternating first and second inorganic optical layers collectively reflect and absorb light that is normally incident to the first major surface of the microstructured film 11, an average of at least 50, 60, 70, 80, 90, or 95 percent (preferably at least 80, 90, or 95 percent) of incident ultraviolet light over at least a 30-nanometer wavelength reflection bandwidth in a wavelength range from 190 nanometers (nm) to 400 nm.

In some cases, the alternating first and second inorganic optical layers collectively reflect and absorb light that is normally incident to the first major surface of the microstructured film 11, an average of at least 60, 70, 80, 90, or 95 percent of incident ultraviolet light over at least a 30-nanometer wavelength reflection bandwidth in a wavelength range from 190 nm to 240 nm, 240 nm to 300 nm, 300 nm to 350 nm, 350 nm to 400 nm, or any combination thereof.

Optionally, the alternating first and second inorganic optical layers collectively reflect and absorb light that is normally incident to the first major surface of the microstructured film 11, an average of at least 60, 70, 80, 90, or 95 percent of incident ultraviolet light over a greater wavelength reflection bandwidth than at least 30-nanometer, for instance at least a 50-nanometer, 75-nanometer. 100-nanometer, 125-nanometer, 150-nanometer, or 175-nanometer wavelength reflection bandwidth in a wavelength range from 190 nm to 400 nm.

As the alternating first and second inorganic optical layers collectively reflect and absorb, some portion of the incident ultraviolet light may be absorbed and some portion reflected. In some cases, the alternating first and second inorganic optical layers collectively absorb light that is normally incident to the first major surface of the microstructured film 11, an average of at least 30, 40, 50, 60, 70, 80, 90, or 95 percent of incident light over at least a 30-nanometer wavelength bandwidth in a wavelength range from 190 nm to less than 350 nm. In some cases, the alternating first and second inorganic optical layers collectively reflect light that is normally incident to the first major surface of the microstructured film 11, an average of at least 30, 40, 50, 60, 70, 80, 90, or 95 percent of incident light over at least a 30-nanometer wavelength bandwidth in a wavelength range from 190 nm to less than 400 nm, 190 nm to 240 nm, 240 nm to 300 nm, 300 nm to 350 nm, 350 nm to less than 400 nm, or any combination thereof.

In select embodiments, the alternating first and second inorganic optical layers collectively transmit light that is normally incident to the first major surface of the microstructured film 11, an average of at least 50, 60, 70, 80, 90, or 95 percent of incident visible light in a wavelength range from greater than 400 nm to 700 nm.

In some embodiments, an article (e.g., as a whole) of the fourth aspect (i.e., an article having just one microstructured film), transmits an average of at least 50, 60, 70, 80, 90, or 95 percent of normally incident visible light in a wavelength range from greater than 400 nm to 700 nm. Transmitting such amounts of incident visible light is particularly useful when the article is used in a solar array application, to allow visible light to reach the solar cells of the array.

In the embodiments of FIG. 1D and FIG. 2, the article 30 further comprises an optional additional layer 14 that is a tie layer, a substrate, or includes both. The additional layer 14 is disposed on a major surface 9 of the second microstructured film 11 opposite the multilayer optical film 5. Numerous different materials are suitable for such a tie and/or substrate layer and the additional layer 14 encompasses a carrier substrate (e.g., self-supporting substrate), a single adhesive layer, an adhesive tape, a double-sided adhesive, tape, a primer tie layer, a film, and the like. As such, the additional layer may be a single layer as depicted in FIG. 1D or may be a plurality of layers.

Referring again to FIG. 2, an article 40 comprises a microstructured film 11 comprising a first major surface 7 and an opposing second major surface 9. The first major surface 7 has a plurality of microstructures projecting therefrom (not shown). The article 40 further comprises a multilayer optical film 5 disposed on the first major surface 7 of the microstructured film 11 and a (co)polymer layer 15 disposed on a major surface 22 of the multilayer optical film 5 opposite the microstructured film 11.

The (e.g., first) microstructured film 18, release layer 16, (co)polymer layer 15, multilayer optical film 5, and optional second (co)polymer layer 17 are each as described in detail above with respect to the transfer articles of the first and second aspects. Optionally, the article further comprises an additional layer 14 that is a tie layer, a substrate, or includes both, as described above with respect to FIG. 1D.

In some embodiments, the (e.g., second) microstructured film 11 comprises a cured polysiloxane, a silicone thermoplastic polymer. PET, a cured urethane, a thermoplastic urethane, a cured (meth)acrylate, a cured epoxy, a cured vinyl ether, a cured oxetane, a cured thiol-acrylate, a cured thiol-enc. PMMA, coPMMA, a polyimide, a cyclic olefin copolymer, a cyclic olefin polymer, a polycarbonate, a PEN, or a fluoropolymer (co)polymer comprising polymerized units derived from one or more monomers selected from tetrafluoroethylene, hexafluoropropylene, vinylidene fluoride, a perfluoroalkoxy alkylene, or a vinyl fluoride, or a combination thereof. Optionally, any of the cured polymeric materials mentioned above are crosslinked. In article(s) of select embodiments of the present disclosure, the (co)polymer layer(s) and/or microstructured film(s) further comprise an additive that is an ultraviolet radiation absorber, a hindered amine light stabilizer, an antioxidant, or a combination thereof, such as any of the additives described above.

In some cases, the second microstructured film comprises a cured polysiloxane, a silicone thermoplastic polymer, or a combination thereof. An advantage of preparing an article from a transfer article is that soft materials such as silicone-based polymers can be used without having to support the deposition of a multilayer optical film on the microstructured film during formation of the article.

When a polyimide or a high temperature fluoropolymer is employed, likely it would be as a generally planar backing layer in combination with another polymeric material (e.g., a cured (meth)acrylate) that forms the microstructures of the microstructured film.

In select embodiments, the second microstructured film comprises a cured urethane, a cured (meth)acrylate, coPMMA, PMMA, or a combination thereof, and the second microstructured film optionally also contains an ultraviolet radiation absorber, a hindered amine light stabilizer, an antioxidant, or a combination thereof. Inclusion of such additives can help protect the microstructured film materials from UV radiation damage.

The article can be subjected to various post-treatments such as heat treatment, UV or vacuum UV (VUV) treatment, e-beam treatment, or plasma treatment. Heat treatment can be conducted by passing the article through an oven or directly heating the article in the coating apparatus, (e.g., using infrared heaters or heating directly on a drum. Heat treatment may for example be performed at temperatures from about 30° C. to about 200° C., about 35° C. to about 150° C., or about 40° C. to about 70° C.

Any first microstructured film, first (co)polymer layer, second (co)polymer layer, release layer, multilayer optical film present in an article according to the third aspect or fourth aspect may be as described in detail above with respect to those films and/or layers for transfer articles of the first aspect or second aspect.

### Methods

In a fifth aspect, a method of making an article is provided. The method comprises:
obtaining a transfer article according to the first or second aspect;
depositing a polymeric material or a crosslinkable material on an exterior major surface of the transfer article opposite the first microstructured film;
curing the polymeric material or crosslinkable material to form a second microstructured film
comprising a first major surface and an opposing second major surface, wherein the first major surface comprises a plurality of microstructures projecting therefrom, wherein at least some of the plurality of microstructures each has a surface whose slope causes light that is normally incident to the first major surface of the second microstructured film to intercept the first major surface or the surface of at least one other microstructure after reflection, and wherein the first major surface of the second microstructured film is adjacent to the multilayer optical film; and
removing the release layer from the transfer article.

In some cases, the transfer article is according to the first aspect and the exterior major surface of the transfer article comprises a major surface of the multilayer optical film opposite the (first) (co)polymer layer. Stated another way, in some cases the transfer article used in the method includes the following layers in order: a microstructured film, a release layer, a (co)polymer layer, and a multilayer optical film, plus the multilayer optical film is an exterior layer of the transfer article. By exterior layer is meant that the layer is an outermost layer of the transfer article.

In some cases, the transfer article is according to the first aspect and the method further comprises removing the (first) (co)polymer layer after removing the release layer. Stated another way, in some cases the transfer article used in the method includes the following layers in order: a microstructured film, a release layer, a (co)polymer layer, and a multilayer optical film, plus the (co)polymer layer adjacent to the multilayer optical film gets removed after detaching the release layer. Often, the (co)polymer layer is removed using etching.

Suitable etching processes are not particularly limited and may include reactive ion etching or etching using any kind of plasma. In one embodiment, the (co)polymer layer is removed by reactive ion etching. Reactive ion etching (RIE) is a directional etching process utilizing ion bombardment to remove material. RIE systems are used to remove organic or inorganic material by etching surfaces orthogonal to the direction of the ion bombardment. The most notable difference between reactive ion etching and isotropic plasma etching is the etch direction. Reactive ion etching is characterized by a ratio of the vertical etch rate to the lateral etch rate which is greater than 1. Systems for reactive ion etching are built around a durable vacuum chamber. Before beginning the etching process, the chamber is evacuated to a base pressure lower than 1 Torr, 100 mTorr, 20 m Torr, 10 mTorr, or 1 mTorr. An electrode holds the materials to be treated and is electrically isolated from the vacuum chamber. The electrode may be a rotatable electrode in a cylindrical shape. A counter electrode is also provided within the chamber and may be comprised of the vacuum reactor walls. Gas comprising an etchant enters the chamber through a control valve. The process pressure is maintained by continuously evacuating chamber gases through a vacuum pump. The type of gas used varies depending on the etch process. Carbon tetrafluoride (CF₄), sulfur hexafluoride (SF₆), octafluoropropane (C₃F₈), fluoroform (CHF₃), boron trichloride (BCl₃), hydrogen bromide (HBr), chlorine, argon, and oxygen are commonly used for etching. RF power is applied to the electrode to generate a plasma. Samples can be conveyed on the electrode through plasma for a controlled time period to achieve a specified etch depth. Reactive ion etching is known in the art and further described in U.S. Pat. No. 8,460,568 (David et al.); incorporated herein by reference. The gas that is used to generate an etching plasma typically includes oxygen gas and a fluorocarbon (e.g., CF₄, C₂F₆, or C₃F₈). The molar concentration of fluorocarbon gas in the mixture is typically 0 to 60% depending upon the particular type of fluorocarbon and on the composition of the (co)polymer layer to be removed. Argon can also be a useful gas for plasma etching in combination with at least one of oxygen or a fluorocarbon. In some embodiments, oxygen alone is used to generate an etching plasma. Typically for plasma etching, power densities in the range from about 0.05 to about 1 watt/square cm (W/cm²) can be applied.

In some cases, the transfer article is according to the second aspect and the exterior major surface of the transfer article comprises a major surface of the first (co)polymer layer.

In select embodiments, the method further comprising depositing a tie layer, a substrate, or both on the second major surface of the second microstructured film. Suitable tie layers and substrates are as described above.

### LISTING OF EXEMPLARY EMBODIMENTS

In a first embodiment is provided a transfer article. The transfer article comprises a microstructured film comprising a first major surface and an opposing second major surface, wherein the first major surface comprises a plurality of microstructures projecting therefrom. At least some of the plurality of microstructures each has a surface whose slope causes light that is normally incident to the first major surface of the microstructured film to intercept the first major surface or the surface of at least one other microstructure after reflection. The transfer article further comprises a release layer disposed on the plurality of microstructures, wherein the release layer comprises a metal layer or a doped semiconductor layer; a (co)polymer layer disposed on a major surface of the release layer opposite the microstructured film; and a multilayer optical film disposed on a major surface of the (co)polymer layer opposite the release layer. The multilayer optical film is comprised of one or more alternating first and second inorganic optical layers collectively reflecting and absorbing light that is normally incident to the first major surface of the microstructured film, an average of at least 50, 60, 70, 80, 90, or 95 percent of incident ultraviolet light over at least a 30-nanometer wavelength reflection bandwidth in a wavelength range from 190 nanometers (nm) to 400 nm.

In a second embodiment is provided a transfer article according to the first embodiment, wherein the microstructured film comprises polyethylene terephthalate (PET), a cured polysiloxane, a silicone thermoplastic polymer, a cured urethane, a thermoplastic urethane, a cured (meth)acrylate, a cured epoxy, a cured vinyl ether, a cured oxetane, a cured thiol-acrylate, a cured thiol-ene, a polypropylene, a polyethylene. PMMA, coPMMA, a polyimide, a cyclic olefin copolymer, a cyclic olefin polymer, a polycarbonate, a polyethylene naphthalate (PEN), or a fluoropolymer (co)polymer comprising polymerized units derived from one or more monomers selected from tetrafluoroethylene, hexafluoropropylene, vinylidene fluoride, a perfluoroalkoxy alkylene, or a vinyl fluoride, or a combination thereof.

In a third embodiment is provided a transfer article according to the first embodiment or the second embodiment, wherein the (co)polymer layer is a first (co)polymer layer and wherein the transfer article further comprises a second (co)polymer layer disposed between the microstructured film and the release layer.

In a fourth embodiment is provided a transfer article according to the third embodiment, wherein at least one of the first (co)polymer layer or the second (co)polymer layer comprises a (co)polymer selected from an olefinic (co)polymer, a (meth)acrylate (co)polymer, a urethane (co)polymer, a fluoropolymer, a silicone (co)polymer, or a combination thereof.

In a fifth embodiment is provided a transfer article according to any of the first through fourth embodiments, wherein the release layer comprises a metal layer comprising at least one selected from the group consisting of individual metals, two or more metals as mixtures, inter-metallics or alloys, semi-metals or metalloids, metal oxides, metal and mixed metal oxides, metal and mixed metal fluorides, metal and mixed metal nitrides, metal and mixed metal carbides, metal and mixed metal carbonitrides, metal and mixed metal oxynitrides, metal and mixed metal borides, metal and mixed metal oxy borides, metal and mixed metal silicides, diamond-like carbon, diamond-like glass, graphene, and combinations thereof.

In a sixth embodiment is provided a transfer article according to any of the first through fifth embodiments, wherein the release layer comprises a copper oxide or a silicon aluminum oxide.

In a seventh embodiment is provided a transfer article according to any of the first through sixth embodiments, wherein the plurality of microstructures have an aspect ratio of height to width of no more than 10:1, 8:1, 6:1, 4:1, 2:1, or 1:1.

In an eighth embodiment is provided a transfer article according to any of the first through seventh embodiments, wherein at least some of the microstructures comprise at least one angled sidewall having a peak angle of 90 degrees or less and 5, 15, 25, 35, or 45 degrees or greater.

In a ninth embodiment is provided a transfer article according to any of the first through eighth embodiments, wherein the surfaces whose slope causes light that is normally incident to the first major surface of the microstructured film to intercept the first major surface or the surface of at least one other microstructure after reflection, each have the same slope.

In a tenth embodiment is provided a transfer article according to any of the first through ninth embodiments, wherein at least some of the microstructures have a shape with a triangular cross-section.

In an eleventh embodiment is provided a transfer article according to any of the first through tenth embodiments, wherein the microstructures have a shape that is a prism, a pyramid, an inverted pyramid, a diffraction grating, an inverted cone, or a conc.

In a twelfth embodiment is provided a transfer article according to any of the first through eleventh embodiments, wherein the microstructures have a height of 0.5 micrometer to 500 micrometers.

In a thirteenth embodiment is provided a transfer article according to any of the first through twelfth embodiments, wherein each of the first and second inorganic optical layers independently has a thickness of 20 nm to 400 nm.

In a fourteenth embodiment is provided a transfer article according to any of the first through thirteenth embodiments, wherein the first optical layer comprises at least one of niobium oxide, titanium oxide, silicon oxynitride, molybdenum oxide, tungsten oxide, silicon nitride, indium tin oxide, hafnium oxide, tantalum oxide, zirconium oxynitride, zirconium oxide, aluminum zinc oxide, or zinc oxide and wherein the second optical layer comprises at least one of silicon oxide, silicon aluminum oxide. N type- or P type-doped silicon oxide, aluminum oxide, aluminum fluoride, magnesium fluoride, calcium fluoride, indium tin oxide, or zinc oxide.

In a fifteenth embodiment is provided a transfer article according to any of the first through fourteenth embodiments, wherein the first optical layer comprises at least one of niobium oxide or titanium oxide, and wherein the second optical layer comprises silicon aluminum oxide.

In a sixteenth embodiment is provided a transfer article according to any of the first through fifteenth embodiments, wherein the multilayer optical film is formed of at least 1 first optical layer and 2 second optical layers.

In a seventeenth embodiment is provided a transfer article according to any of the first through sixteenth embodiments, wherein the first (co)polymer layer is substantially transparent.

In an eighteenth embodiment is provided an article. The article comprises a first microstructured film comprising a first major surface and an opposing second major surface, wherein the first major surface comprises a plurality of microstructures projecting therefrom. At least some of the plurality of microstructures each has a surface whose slope causes light that is normally incident to the first major surface of the first microstructured film to intercept the first major surface or the surface of at least one other microstructure after reflection. The article further includes a release layer disposed on the plurality of microstructures, wherein the release layer comprises a metal layer or a doped semiconductor layer; a (co)polymer layer disposed on a major surface of the release layer opposite the first microstructured film; a multilayer optical film disposed on a major surface of the (co)polymer layer opposite the release layer; and a second microstructured film adjacent to a major surface of the multilayer optical film opposite the (co)polymer layer. The second microstructured film comprises a first major surface and an opposing second major surface, wherein the first major surface comprises a plurality of microstructures projecting therefrom, wherein at least some of the plurality of microstructures each has a surface whose slope causes light that is normally incident to the first major surface of the second microstructured film to intercept the first major surface or the surface of at least one other microstructure after reflection. The multilayer optical film is comprised of one or more alternating first and second inorganic optical layers collectively reflecting and absorbing light that is normally incident to the first major surface of the second microstructured film, an average of at least 50, 60, 70, 80, 90, or 95 percent of incident ultraviolet light over at least a 30-nanometer wavelength reflection bandwidth in a wavelength range from 190 nanometers (nm) to 400 nm.

In a nineteenth embodiment is provided an article according to the eighteenth embodiment, wherein the second microstructured film comprises a cured polysiloxane, a silicone thermoplastic polymer, polyethylene terephthalate (PET), a cured urethane, a thermoplastic urethane, a cured (meth)acrylate. PMMA, coPMMA, a polyimide, a cyclic olefin copolymer, a cyclic olefin polymer, a polycarbonate, a polyethylene naphthalate (PEN), or a fluoropolymer (co)polymer comprising polymerized units derived from one or more monomers selected from tetrafluoroethylene, hexafluoropropylene, vinylidene fluoride, a perfluoroalkoxy alkylene, or a vinyl fluoride, or a combination thereof.

In a twentieth embodiment is provided an article according to the eighteenth embodiment or the nineteenth embodiment, wherein the second microstructured film comprises a cured urethane, a cured (meth)acrylate, coPMMA, PMMA, or a combination thereof, and the second microstructured film optionally also contains an ultraviolet radiation absorber, a hindered amine light stabilizer, an antioxidant, or a combination thereof.

In a twenty-first embodiment is provided an article according to the eighteenth embodiment or the nineteenth embodiment, wherein the second microstructured film comprises a cured polysiloxane, a silicone thermoplastic polymer, or a combination thereof.

In a twenty-second embodiment is provided an article according to any of the eighteenth through twenty-first embodiments, wherein the (co)polymer layer is a first (co)polymer layer and wherein the article further comprises a second (co)polymer layer disposed between the first microstructured film and the release layer.

In a twenty-third embodiment is provided an article according to any of the eighteenth through twenty-second embodiments, further comprising a tie layer, a substrate, or both disposed on a major surface of the second microstructured film opposite the multilayer optical film.

In a twenty-fourth embodiment is provided an article according to any of the eighteenth through twenty-third embodiments, wherein the second microstructured film is directly adjacent to the multilayer optical film.

In a twenty-fifth embodiment is provided another article. The article comprises a microstructured film comprising a first major surface and an opposing second major surface, wherein the first major surface comprises a plurality of microstructures projecting therefrom. At least some of the plurality of microstructures each has a surface whose slope causes light that is normally incident to the first major surface of the microstructured film to intercept the first major surface or the surface of at least one other microstructure after reflection. The article further comprises a multilayer optical film disposed on the plurality of microstructures and a (co)polymer layer disposed on a major surface of the multilayer optical film opposite the microstructured film. The multilayer optical film is comprised of one or more alternating first and second inorganic optical layers collectively reflecting and absorbing light that is normally incident to the first major surface of the microstructured film, an average of at least 50, 60, 70, 80, 90, or 95 percent of incident ultraviolet light over at least a 30-nanometer wavelength reflection bandwidth in a wavelength range from 190 nanometers (nm) to 400 nm.

In a twenty-sixth embodiment is provided an article according to the twenty-fifth embodiment, further comprising a tie layer, a substrate, or both disposed on the second major surface of the microstructured film.

In a twenty-seventh embodiment is provided an article according to the twenty-fifth embodiment or the twenty-sixth embodiment, which transmits light that is normally incident to the first major surface of the second microstructured film, an average of at least 50, 60, 70, 80, 90, or 95 percent of normally incident visible light in a wavelength range from greater than 400 nm to 700 nm.

In a twenty-eighth embodiment is provided an article according to any of the twenty-fifth through twenty-seventh embodiments, wherein an average transmission of wavelengths between 400 nm and 700 nm through the article is reduced by less than 20%, 10%, 5%, or less than 1% after exposure to a dose of 425 megajoules per square meter (MJ/m²) of ultraviolet light.

In a twenty-ninth embodiment is provided another transfer article. The transfer article comprises a microstructured film comprising a first major surface and an opposing second major surface, wherein the first major surface comprises a plurality of microstructures projecting therefrom. At least some of the plurality of microstructures each has a surface whose slope causes light that is normally incident to the first major surface of the microstructured film to intercept the first major surface or the surface of at least one other microstructure after reflection. The transfer article further includes a release layer disposed on the plurality of microstructures, wherein the release layer comprises a metal layer or a doped semiconductor layer; and a (co)polymer layer disposed on a major surface of the release layer opposite the microstructured film, wherein the (co)polymer layer further comprises an ultraviolet radiation absorber, a hindered amine light stabilizer, an antioxidant, or a combination thereof.

In a thirtieth embodiment is provided a transfer article according to the twenty-ninth embodiment, wherein the (co)polymer layer is a first (co)polymer layer and wherein the transfer article further comprises a second (co)polymer layer disposed between the microstructured film and the release layer.

In a thirty-first embodiment is provided a method of making an article. The method comprises obtaining a transfer article according to any of the first through seventeenth embodiments, the twenty-ninth embodiment, or the thirtieth embodiment; depositing a polymeric material or a crosslinkable material on an exterior major surface of the transfer article opposite the first microstructured film: curing the polymeric material or crosslinkable material to form a second microstructured film; and removing the release layer from the transfer article. The second microstructured film comprises a first major surface and an opposing second major surface, wherein the first major surface comprises a plurality of microstructures projecting therefrom, wherein at least some of the plurality of microstructures each has a surface whose slope causes light that is normally incident to the first major surface of the second microstructured film to intercept the first major surface or the surface of at least one other microstructure after reflection, and wherein the first major surface of the second microstructured film is adjacent to the multilayer optical film.

In a thirty-second embodiment is provided a method according to the thirty-first embodiment, wherein the transfer article is according to any of the first through seventeenth embodiments and the exterior major surface of the transfer article comprises a major surface of the multilayer optical film opposite the first (co)polymer layer.

In a thirty-third embodiment is provided a method according to the thirty-first embodiment or the thirty-second embodiment, wherein the transfer article is according to any of the first through seventeenth embodiments and the method further comprises removing the first (co)polymer layer after removing the release layer.

In a thirty-fourth embodiment is provided a method according to the thirty-third embodiment, wherein the first (co)polymer layer is removed using etching.

In a thirty-fifth embodiment is provided a method according to the thirty-first embodiment, wherein the transfer article is according to the twenty-ninth embodiment or the thirtieth embodiment and the exterior major surface of the transfer article comprises a major surface of the first (co)polymer layer.

In a thirty-sixth embodiment is provided a method according to any of the thirty-first through thirty-fifth embodiments, further comprising depositing a tie layer, a substrate, or both on the second major surface of the second microstructured film.

### EXAMPLES

Unless otherwise noted or readily apparent from the context, all parts, percentages, ratios, etc. in the Examples and the rest of the specification are by weight.

| Abbreviation | Description and Source |
|---|---|
| BEF4 | A microstructured film with 1-dimensional prisms, peak angle of 90 |
| | degrees, and pitch of 24 um, obtained under tradename “3M ™ Brightness |
| | Enhancement Films BEF4-GT” from 3M Company; St. Paul, MN |
| TiO₂ | TiO₂ source material was purchased under trade name “Titanium Oxide |
| | tablets, TiO₂, 99.9% pure” from Kurt J Lesker Company; Jefferson Hills, |
| | PA. |
| SiO₂ | SiO₂ source material was purchased under trade name “Silicon Oxide |
| | Pieces, SiO₂, 99.99% pure” from Kurt J Lesker Company; Jefferson |
| | Hills, PA. |
| Silicon chip | Silicon wafers cut into 0.75″ × 0.75″ pieces, obtained under part number |
| | “452” from University Wafer Inc; South Boston, MA |
| Cu | >99% copper (Cu) target, obtained from Soleras Advanced Coatings US; |
| | Biddeford, ME |
| SR833 | Tricyclodecane dimethanol diacrylate monomer, obtained under the trade |
| | designation “SR833S” from Sartomer USA, Exton, PA. |
| Sylgard 184 | Transparent, heat curable silicone elastomer, obtained under tradename |
| | “SYLGARD ™ 184 Silicone Elastomer” from Dow Chemical Company; |
| | Midland, MI |
| DC 93-500 | Transparent, heat curable space grade silicone elastomer, obtained under |
| | tradename “DOWSIL ™ 93-500 Space Grade Encapsulant” from Dow |
| | Chemical Company; Midland, MI |
| 3M Vinyl Tape | Obtained under tradename “3M Vinyl Tape 471” from 3M Company, St. |
| | Paul, MN |
| 3M Polyester Tape | Obtained under tradename “3M Polyester Tape 8402” from 3M |
| | Company, St. Paul, MN |

### Test Methods

Spectral Properties Modeling Test: Prior to fabricating the articles, we modeled the optical properties (transmission, reflection, and absorption) of the intended inorganic coating to precisely determine the necessary thicknesses of the optical coating layers. To perform this modeling, Test Samples 1 and 2 were measured with an ellipsometer (obtained under tradename “RC2 Ellipsometer” from J. A. Woolam; Lincoln, NE) to determine the spectral index of refraction (n) and extinction coefficient (k) values of the evaporated TiO₂ and SiO₂ samples. Then the n and k obtained above were input into optical modeling software (obtained under tradename “Essential MaCleod” from The Thin Film Center; Tucson. AZ) and used to compute the reflection, transmission, and absorption spectra for the multilayer optical films prepared as described below. All structures were modeled with a PET substrate, with an incident angle of 45 degrees, with the highest numbered oxide layer of the coatings facing towards air. SR833 and silicone layers were not included in the modeling. The results of the reflection, absorption, and transmission modeling are reported as an average percent over a wavelength range in the Reflection and Absorption Results Table and Transmission Results Table. Note that the modeling only calculates the transmission, reflection, and absorption of the inorganic optical coatings: the modeling does not calculate the absorption or back surface reflection of the substrate material.

Spectral Properties Measurement Test: The spectral transmission and reflection of freestanding examples of articles were measured using a spectrophotometer (obtained under the trade designation “LAMBDA 1050” from PerkinElmer. Inc., Waltham. MA). Absorption was calculated (in units of percentage) as 100-Reflection-Transmission. The measured spectral reflection, absorption, and transmission are reported as an average percent over a wavelength range in the Reflection and Absorption Results Table and Transmission Results Table.

Solar Aging Test: Samples were exposed in an Atlas Ci5000 WeatherOmeter (obtained from AMETEK. Berwyn. PA) using a xenon arc lamp equipped with quartz inner and outer filters. The xenon lamp gives a close approximation to the shape of solar output (ASTM E490), and the quartz filter set provides minimal attenuation to the spectral power distribution of the xenon lamp. Samples were exposed on custom-made stainless steel and aluminum holders. The exposure plane was 19 inches (48.3 cm) away from the core of the lamp. Irradiance was controlled at 1.3 watts per square meter (W/m²) at 340 nm at the rack. Ambient air temperature inside the Weatherometer was controlled at 47° C. a black-panel thermometer (BPT) was controlled at 70° C. at the rack plane, and relative humidity was controlled at 30%. Samples were exposed with aluminum panels as backing. Samples were exposed to a dose of at least 425 megajoules per square meter (MJ/m²) cumulative irradiance from 250-385 nm.

The change in transmission was calculated as

$$\% reduction in transmission = \frac{{T}_{Fresh} - {T}_{Aged}}{{T}_{Fresh}}$$

where T_{fresh} is the average transmission from 400-700 nm before solar aging, and T_{aged} is the average transmission from 400-700 nm after the above exposure. The results of the Solar Aging Test are summarized in the Solar Aging Results Table.

Transfer Test: A Transfer Test was used to determine if it was possible to transfer a multilayer optical film from being attached (either directly or indirectly) to one microstructured substrate to being attached to another microstructured substrate, i.e., to determine whether, for a given article with a first microstructured film and a second microstructured film, with a multilayer optical film disposed between the first and second microstructured films (optionally with one or more additional layers also located between the first and second microstructured films), it is possible to separate the first and second microstructured films such that there was transfer of the multilayer optical film from being attached to the first microstructured film to being attached to the second microstructured film. For this test, we started with an article of Example 3, Example 6, or Comparative Example 1.

Attempting to separate the first and second microstructured films was performed with the following method. First, a fresh razor blade was used to cut into the second microstructured film side of the article, the cut defining a rectangular area that is smaller than the original piece of article, and large enough to enable subsequent characterization, e.g., using a starting piece of article that is 2 inches by 2 inches (5.08 centimeters×5.08 centimeters), and cutting an area that is 1.5 inches by 1.5 inches (3.81 centimeters×3.81 centimeters), which is large enough for spectral characterization. When cutting this area, care was taken to cut fully through the second microstructured film and into the first microstructured film without fully cutting through the first microstructured film. Next, the article was placed on a work table with the first microstructured surface facing down and the second microstructured film side facing up, and the corners of the second microstructured film were taped down to the worktable with 3M Polyester Tape by placing the tape onto the second microstructured film surface as well as the work table. The corners were taped to the worktable to prevent the substrate from lifting during the separation operation. Next, a piece of 3M Polyester Tape was placed over one edge of the rectangular cut area of second microstructured film, such that the 3M Polyester Tape extended only 1 centimeter (cm) into the rectangular area. Then the tape was used as a mechanical handle to attempt to pull apart and separate the second microstructured film from the first microstructured film. The results of the separation attempt were recorded qualitatively, e.g., “could not separate first and second microstructured films”, “films successfully separated”, etc. Then, if separation was possible, the separated piece of second microstructured film was characterized to determine if transfer of the multilayer optical film occurred (i.e., by measuring the optical properties of the films to look for the optical signatures of the multilayer optical films), and the results of this characterization were reported qualitatively, e.g., the optical signature of a vapor coated multilayer film was/was not present on second microstructured film. The results of the Transfer Test are reported in the Transfer Test Results Table below.

### Test Samples

Test Sample 1: A 70 nm-thick TiO₂ layer was deposited on a silicon chip in the following manner: the vapor coater used was a Denton Vacuum Optical Coater consisting of a 5-planet planetary drive system located ˜30″ (76.2 cm) above a 4-pocket Temescal Electron Beam gun (obtained from Ferro Tec Corporation. Livermore, CA). The planetary drive system was designed to hold the substrate perpendicular to the evaporation source and to move that disk in a planetary type motion in and out of the evaporation plume during the deposition. The actual process for the coating consisted of: a) The vapor coater was vented to atmosphere and one the five planets was removed. We prepared the substrate for coating by adhering/taping it to the planet by a polyimide tape. b) The planet was reinstalled, and the other 4 planets were configured similarly, if needed, and they too were reinstalled in the coater, c) The chamber was closed and pumped to a vacuum level of <2×10⁻⁵ Torr (2.7×10⁻³ Pa). d) When the vapor coater was at a low enough vacuum, we ion beam treated the material using a Kaufman-type ion source for ˜10 minutes at a voltage of 400V as a pretreatment to the substrate for adhesion of the vapor deposited coating to the substrate prior to applying the oxide films. e) We added oxygen gas via a MKS mass flow controller (obtained from MKS Instruments, Inc., Andover, MA) to obtain a pressure of 4.0×10⁻⁵ Torr (5.3×10⁻³ Pa). This was usually about 10 standard cubic centimeters per minute (sccm) for added oxygen gas. f) The planetary was started and moved around the coater at a rotational speed of ˜60 rpm to prepare for coating and to achieve a high level of uniformity on the attached substrates, g) A Temescal electron beam gun power supply was energized. A voltage of 10 kV and a current of a few milliamps was applied to the e-gun's filament, heating the source material in the e-gun. The source was heated and controlled via an Eddy Company Optical Monitoring System (OMS) (from Eddy Company. Apple Valley, CA). The source was heated until the desired deposition rate of the material was achieved: in the case of TiO₂ this rate was 2 angstroms per second, and in the case of SiO₂ this was 4 angstroms per second. When the desired deposition rate of the material was achieved and steady, a shutter that separates the source from the planets was opened and the rate was maintained via the OMS until the desired optical thickness was achieved, at which point the shutter closed and the OMS shuts power off to the e-beam source. h) The main power to the power supply was turned off and the source allowed to cool for about 10 minutes. i) This process was repeated for additional layers/types of material until the full desired multilayer optical film had been deposited. j) The chamber was then vented back to atmospheric pressure via N₂ gas and each planet was removed and the substrate was removed from each planet.

Test Sample 2: a 115 nm-thick SiO₂ layer was deposited on a silicon chip in the same manner as Test Sample 1.

### EXAMPLES

### Example 1

A transferrable structured acrylate was made on a roll-to-roll vacuum coater similar to the coater described in U.S. Patent Application No. 2010/0316852 (Condo, et al.) with the addition of a second evaporator and curing system located between the plasma pretreatment station and the first sputtering system, and using evaporators as described in U.S. Pat. No. 8,658,248 (Anderson et al.). This coater was outfitted with substrate in the form of an indefinite length roll of 0.05 mm thick, 14 inch (35.6 cm) wide BEF4, with the BEF4 oriented such that the microstructured surface of the BEF4 would be exposed to treatment/coating processes. The BEF4 was prepared for coating by subjecting it to a nitrogen plasma treatment to improve the adhesion of a copper oxide (CuOx) layer on the BEF4 surface. The film was treated with a nitrogen plasma operating at 20 W using a titanium cathode, using a web speed of 34 fpm (10.3 meters/minute) and maintaining the backside of the film in contact with a coating drum chilled to 0° C. On this nitrogen plasma treated BEF4 substrate surface, a release layer of CuOx was deposited in a second pass. The CuOx deposition used a conventional direct current (DC) sputtering process with a Cu target operated at 1 kW of power to deposit a 20 nm thick layer onto the substrate at a line speed of 3 fpm (0.9 m/min) with 120 sccm O₂ and 450 sccm Ar in the sputtering zone. The CuOx coated BEF4 substrate was then rewound.

In a third pass at a line speed of 17 fpm an estimated thickness 500 nm acrylate layer of SR833 was formed on top of the CuOx layer. The acrylate layer was applied by ultrasonic atomization and flash evaporation to make a coating width of 12.5 inches (31.8 cm). The flow rate of the SR833 into the atomizer was 1.33 mL/min, the N₂ carrier gas flow rate was 60 sccm, and the evaporator temperature was 260° C. Once condensed onto the CuOx layer, this monomeric coating was cured immediately with an electron beam curing gun operating at 7.0 kV and 4.0 mA.

After removing the BEF4 from vacuum, 3M Vinyl Tape was laminated by hand with a 3M-71601 rigid plastic squeegee to ensure vinyl adhesive contact to the entire structured SR833 acrylate layer. Peeling the adhesive by hand confirmed that the acrylate layer could be fully removed from the CuOx layer that remained well bound to the BEF4.

### Example 2

A vapor coated multilayer optical film was prepared in the same manner as Test Sample 1, except an Example 1 film was used for the substrate, and the structure deposited on the Example 1 substrate is summarized in the Examples Structure Table below. The Example 1 substrate was taped to the planet such that the structured/coated side of the Example 1 substrate would be coated by the vapor coating process.

One important factor to consider when preparing vapor coatings on microstructured substrates is the geometry of the substrate. The slope of the structure will result in an increased surface area for a microstructured substrate relative to a planar substrate. As a result of this increased surface area, the same deposition process of material onto a microstructured substrate and a planar substrate will result in a thinner coating on the surface of the microstructured substrate than on the planar substrate. In other words, the fixed deposition process deposits a fixed volume of material onto the substrates, so the substrate with higher surface area receives a thinner coating overall (coating thickness=volume of material deposited divided by surface area of substrate).

Therefore, in order to achieve a particular thickness on a microstructured substrate, it is necessary to increase the total volume of material deposited. The volume of material should be increased by a factor equal to the ratio of the surface area of the microstructured substrate and the planar substrate. In the case of an Example 1 substrate, which has one-dimensional prisms with a peak angle of 90 degrees, and therefore a slope of 45 degrees, it is necessary to increase the volume of material deposited by a factor equal to 1/SIN(peak angle/2)=1/SIN (45°)=1.414.

### Example 3

A layer of Sylgard 184 curable silicone elastomer was coated onto a piece of Example 2 and cured. The Sylgard 184 curable silicone was prepared and applied in the following manner: The Sylgard 184 processing, mixing, handling, etc. all occurred at ambient conditions. The Sylgard 184 silicone elastomer base and the Sylgard 184 silicone elastomer curing agent were poured together into a glass jar at a mass ratio of 10:1 base:curing agent. The material was mixed with a wooden tongue depressor for one minute, taking care to avoid air entrapment. The mixture was allowed to rest for one hour to allow trapped air to degas. The mixture was then slowly poured onto the center of a piece of Example 2 until the entire piece was covered with the Sylgard 184. The Sylgard 184 was then allowed to cure for 48 hours at ambient conditions.

### Example 4

A cured, prismatic Sylgard 184 silicone elastomer with a transferred vapor coating was prepared by taking a piece of Example 3 after the Sylgard 184 had fully cured, and then peeling the film substrate apart from the Sylgard 184 coating. Peeling the silicone apart from the substrate was accomplished by using a razor blade to cut out the desired area of film to be peeled off, taking care to cut just the silicone layer without cutting the substrate. The corners of the substrate were taped down to a worktable with 3M Polyester Tape to prevent the substrate from lifting during the peeling operation. Then a piece of 3M Polyester Tape was placed on one edge of the silicone in the area to be peeled, such that the 3M Polyester Tape did not cover the entire area to be peeled, and then the tape was used as a mechanical handle to peel the silicone away from the substrate. The tape was pulled in the direction orthogonal to the long direction the BEF4 substrate prismatic features, in other words pulled in the prism peak-to-peak direction. This operation caused release of the SR833 layer from the CuOx layer, resulting in a microstructured Sylgard 184 film coated with SiO₂, TiO₂, and SR833 layers per the Examples Structure Table below.

### Example 5

Example 5 was prepared in the same manner as Example 2, except with layers as described in the Examples Structure Table.

### Example 6

Example 6 was prepared in the same manner as Example 3, with the following changes: in place of an Example 2 film as substrate, an Example 5 film was used as the substrate; and in place of Sylgard 184, DC 93-500 was used. The DC 93-500 curable silicone was prepared and applied in the following manner: The DC 93-500 processing, mixing, handling, etc. all occurred at ambient conditions. The DC 93-500 silicone elastomer base and the DC 93-500 silicone elastomer curing agent were poured together into a glass jar at a mass ratio of 10:1 base:curing agent. The material was mixed with a wooden tongue depressor for one minute, taking care to avoid air entrapment. The mixture was allowed to rest for 1 hour to allow trapped air to degas. The mixture was then slowly poured onto the center of a piece of Example 5 until the entire piece was covered with the DC 93-500. The DC 93-500 was then allowed to cure for 48 hours at ambient conditions.

### Example 7

Example 7, a cured prismatic DC 93-500 silicone elastomer with a transferred vapor coating, was prepared by taking a piece of Example 6 after the DC 93-500 had fully cured, and peeling the film substrate apart from the DC 93-500 silicone coating. Peeling the silicone apart from the substrate was accomplished by using a razor blade to cut out the desired area of film to be peeled off, taking care to cut just the silicone layer without cutting the substrate. The corners of the substrate were taped down to a worktable with 3M Polyester Tape to prevent the substrate from lifting during the peeling operation. Then a piece of 3M Polyester Tape was placed on one edge of the silicone in the area to be peeled, such that the 3M Polyester Tape did not cover the entire area to be peeled, and then the tape was used as a mechanical handle to peel the silicone away from the substrate. The tape was pulled in the direction orthogonal to the long direction the BEF4 substrate prismatic features, in other words pulled in the prism peak-to-peak direction. This operation caused release of the SR833 layer from the CuOx layer, resulting in a microstructured DC 93-500 film coated with SiO₂, TiO₂, and SR833 layers per the Examples Structure Table below.

### Comparative Example 1

Comparative Example 1 was prepared by first depositing a vapor coated multilayer optical film in the same manner as Example 2, but using a piece of BEF4 as substrate instead of a piece of Example 1. The structure of the vapor coated multilayer optical film can be seen in layers 1-11 in the Comparative Examples Structure Table. Then a layer of DC 93-500 curable silicone elastomer was coated and cured onto the outer surface (layer 12) of the vapor coated multilayer optical film in the manner used to coat and cure the DC 93-500 layer in Example 6.

### Comparative Example 2

Comparative Example 2 was a piece of BEF4 film.

Examples Structure Table Layer 1 is in contact with the substrate.

| Sample | Example 1 | Example 2 | Example 3 | Example 4 |
|---|---|---|---|---|
| Substrate | BEF4 | BEF4 | BEF4 | Sylgard 184 |
| Layer 1 | CuOx/20 nm | CuOx/20 nm | CuOx/20 nm | SiO₂/140.8 nm |
| Layer 2 | SR833/500 nm | SR833/500 nm | SR833/500 nm | TiO₂/31.6 nm |
| Layer 3 | | SiO₂/55.1 nm | SiO₂/55.1 nm | SiO₂/55.1 nm |
| Layer 4 | | TiO₂/31.6 nm | TiO₂/31.6 nm | TiO₂/37.2 nm |
| Layer 5 | | SiO₂/55.1 nm | SiO₂/55.1 nm | SiO₂/55.1 nm |
| Layer 6 | | TiO₂/37.2 nm | TiO₂/37.2 nm | TiO₂/37.2 nm |
| Layer 7 | | SiO₂/55.1 nm | SiO₂/55.1 nm | SiO₂/55.1 nm |
| Layer 8 | | TiO₂/37.2 nm | TiO₂/37.2 nm | TiO₂/37.2 nm |
| Layer 9 | | SiO₂/55.1 nm | SiO₂/55.1 nm | SiO₂/55.1 nm |
| Layer 10 | | TiO₂/37.2 nm | TiO₂/37.2 nm | TiO₂/31.6 nm |
| Layer 11 | | SiO₂/55.1 nm | SiO₂/55.1 nm | SiO₂/55.1 nm |
| Layer 12 | | TiO₂/31.6 nm | TiO₂/31.6 nm | SR833/500 nm |
| Layer 13 | | SiO₂/140.8 nm | SiO₂/140.8 nm | |
| Layer 14 | | | Sylgard 184 | |

| Example 5 | Example 6 | Example 7 |
|---|---|---|
| BEF4 | BEF4 | DC 93-500 |
| CuOx/20 nm | CuOx/20 nm | SiO₂/55.1 nm |
| SR833/500 nm | SR833/500 nm | TiO₂/31.6 nm |
| SiO₂/140.8 nm | SiO₂/140.8 nm | SiO₂/55.1 nm |
| TiO₂/31.6 nm | TiO₂/31.6 nm | TiO₂/37.2 nm |
| SiO₂/55.1 nm | SiO₂/55.1 nm | SiO₂/55.1 nm |
| TiO₂/37.2 nm | TiO₂/37.2 nm | TiO₂/37.2 nm |
| SiO₂/55.1 nm | SiO₂/55.1 nm | SiO₂/55.1 nm |
| TiO₂/37.2 nm | TiO₂/37.2 nm | TiO₂/37.2 nm |
| SiO₂/55.1 nm | SiO₂/55.1 nm | SiO₂/55.1 nm |
| TiO₂/37.2 nm | TiO₂/37.2 nm | TiO₂/31.6 nm |
| SiO₂/55.1 nm | SiO₂/55.1 nm | SiO₂/140.8 nm |
| TiO₂/31.6 nm | TiO₂/31.6 nm | SR833/500 nm |
| SiO₂/55.1 nm | SiO2/55.1 nm | |
| | DC 93-500 | |

Comparative Examples Structure Table Layer
1 is in contact with the substrate.

| Sample | Comparative Example 1 | Comparative Example 2 |
|---|---|---|
| Substrate | BEF4 | BEF4 |
| Layer 1 | SiO₂/55.1 nm | |
| Layer 2 | TiO₂/31.6 nm | |
| Layer 3 | SiO₂/55.1 nm | |
| Layer 4 | TiO₂/37.2 nm | |
| Layer 5 | SiO₂/55.1 nm | |
| Layer 6 | TiO₂/37.2 nm | |
| Layer 7 | SiO₂/55.1 nm | |
| Layer 8 | TiO₂/37.2 nm | |
| Layer 9 | SiO₂/55.1 nm | |
| Layer 10 | TiO₂/31.6 nm | |
| Layer 11 | SiO₂/140.8 nm | |
| Layer 12 | DC 93-500 | |

Reflection and Absorption Results Table

| | Average Reflectance | | Average Absorption | |
|---|---|---|---|---|
| Example | 200-400 nm (%) | | 200-400 nm (%) | |
| Sample | Measured | Modeled | Measured | Modeled |
| Example 1 | NA | NA | NA | NA |
| Example 2 | NA | 41.0 | NA | 50.7 |
| Example 3 | NA | 41.0 | NA | 50.7 |
| Example 4 | 17.3 | 41.8 | 64.3 | 51.7 |
| Example 5 | NA | 41.8 | NA | 51.7 |
| Example 6 | NA | 41.8 | NA | 51.7 |
| Example 7 | 18.9 | 41.0 | 64.8 | 50.7 |
| Comparative | NA | 41.0 | NA | 50.7 |
| Example 1 | | | | |
| Comparative | 6.0 | NA | 57.3 | NA |
| Example 2 | | | | |

Transmission Results Table

| | |
|---|---|
| | Average Transmission |
| Example | 400-700 nm (%) |

| Sample | Measured | Modeled |
|---|---|---|
| Example 1 | NA | NA |
| Example 2 | NA | 96.7 |
| Example 3 | NA | 96.7 |
| Example 4 | 95.3 | 87.7 |
| Example 5 | NA | 87.7 |
| Example 6 | NA | 87.7 |
| Example 7 | 95.6 | 96.7 |
| Comparative | NA | 96.7 |
| Example 1 | | |
| Comparative | 95.7 | NA |
| Example 2 | | |

Solar Aging Results Table

| Example | Reduction in Transmission | |
|---|---|---|
| Sample | after UV exposure (%) | Dose (MJ/m²) |
| Example 1 | NA | NA |
| Example 2 | NA | NA |
| Example 3 | NA | NA |
| Example 4 | 1.7 | 439 |
| Example 5 | NA | NA |
| Example 6 | NA | NA |
| Example 7 | 0.3 | 483 |
| Comparative | NA | NA |
| Example 1 | | |
| Comparative | 22.6 | 479 |
| Example 2 | | |

Transfer Test Results Table

| Example sample | Separation result | Transfer Result |
|---|---|---|
| Example 1 | NA | NA |
| Example 2 | NA | NA |
| Example 3 sample | First (BEF4) and second | Optical signature of vapor coated multilayer |
| | (Sylgard 184) | optical film present on Sylgard184. Vapor coated |
| | microstructured films | multilayer optical film and copolymer layers |
| | separated successfully. | transferred from BEF4 to Sylgard 184, creating |
| | | Example 4 sample |
| Example 4 | NA | NA |
| Example 5 | NA | NA |
| Example 6 sample | First (BEF4) and second | Optical signature of vapor coated multilayer |
| | (DC 93-500) | optical film present on DC 93-500. Vapor coated |
| | microstructured films | multilayer optical film and copolymer layers |
| | separated successfully | transferred from BEF4 to DC 93-500, creating |
| | | Example 7 sample |
| Comparative | First (BEF4) and second | NA |
| Example 1 | (DC 93-500) | |
| | microstructured films | |
| | could not be separated. | |
| Comparative | NA | NA |
| Example 2 | | |

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

Furthermore, all publications and patents referenced herein are incorporated by reference in their entirety to the same extent as if each individual publication or patent was specifically and individually indicated to be incorporated by reference. In the event of inconsistencies or contradictions between portions of the incorporated references and this application, the information in the preceding description. Various exemplary embodiments have been described. These and other embodiments are within the scope of the following claims.

1. A transfer article comprising:
a microstructured film comprising a first major surface and an opposing second major surface, wherein the first major surface comprises a plurality of microstructures projecting therefrom, wherein at least some of the plurality of microstructures each has a surface whose slope causes light that is normally incident to the first major surface of the microstructured film to intercept the first major surface or the surface of at least one other microstructure after reflection;
a release layer disposed on the plurality of microstructures, wherein the release layer comprises a metal layer or a doped semiconductor layer;
a (co)polymer layer disposed on a major surface of the release layer opposite the microstructured film; and
a multilayer optical film disposed on a major surface of the (co)polymer layer opposite the release layer, wherein the multilayer optical film is comprised of one or more alternating first and second inorganic optical layers collectively reflecting and absorbing light that is normally incident to the first major surface of the microstructured film, an average of at least 50, 60, 70, 80, 90, or 95 percent of incident ultraviolet light over at least a 30-nanometer wavelength reflection bandwidth in a wavelength range from 190 nanometers (nm) to 400 nm.

2. The transfer article of claim 1, wherein the microstructured film comprises polyethylene terephthalate (PET), a cured polysiloxane, a silicone thermoplastic polymer, a cured urethane, a thermoplastic urethane, a cured (meth)acrylate, a cured epoxy, a cured vinyl ether, a cured oxetane, a cured thiol-acrylate, a cured thiol-ene, a polypropylene, a polyethylene, PMMA, coPMMA, a polyimide, a cyclic olefin copolymer, a cyclic olefin polymer, a polycarbonate, a polyethylene naphthalate (PEN), or a fluoropolymer (co)polymer comprising polymerized units derived from one or more monomers selected from tetrafluoroethylene, hexafluoropropylene, vinylidene fluoride, a perfluoroalkoxy alkylene, or a vinyl fluoride, or a combination thereof.

3. (canceled)

4. The transfer article of claim 3, wherein at least one of the first (co)polymer layer or the second (co)polymer layer comprises a (co)polymer selected from an olefinic (co)polymer, a (meth)acrylate (co)polymer, a urethane (co)polymer, a fluoropolymer, a silicone (co)polymer, or a combination thereof.

5. The transfer article of claim 1, wherein the release layer comprises a metal layer comprising at least one selected from the group consisting of individual metals, two or more metals as mixtures, inter-metallics or alloys, semi-metals or metalloids, metal oxides, metal and mixed metal oxides, metal and mixed metal fluorides, metal and mixed metal nitrides, metal and mixed metal carbides, metal and mixed metal carbonitrides, metal and mixed metal oxynitrides, metal and mixed metal borides, metal and mixed metal oxy borides, metal and mixed metal silicides, diamond-like carbon, diamond-like glass, graphene, and combinations thereof.

6. The transfer article of claim 1, wherein the release layer comprises a copper oxide or a silicon aluminum oxide.

7. The transfer article of claim 1, wherein at least some of the microstructures comprise at least one angled sidewall having a peak angle of 90 degrees or less and 5, 15, 25, 35, or 45 degrees or greater.

8. The transfer article of claim 1, wherein the surfaces whose slope causes light that is normally incident to the first major surface of the microstructured film to intercept the first major surface or the surface of at least one other microstructure after reflection, each have the same slope.

9. (canceled)

10. The transfer article of claim 1, wherein the microstructures have a shape that is a prism, a pyramid, an inverted pyramid, a diffraction grating, an inverted cone, or a cone.

11. The transfer article of claim 1, wherein each of the first and second inorganic optical layers independently has a thickness of 20 nm to 400 nm.

12. The transfer article of claim 1, wherein the first optical layer comprises at least one of niobium oxide, titanium oxide, silicon oxynitride, molybdenum oxide, tungsten oxide, silicon nitride, indium tin oxide, hafnium oxide, tantalum oxide, zirconium oxynitride, zirconium oxide, aluminum zinc oxide, or zinc oxide and wherein the second optical layer comprises at least one of silicon oxide, silicon aluminum oxide, N type- or P type-doped silicon oxide, aluminum oxide, aluminum fluoride, magnesium fluoride, calcium fluoride, indium tin oxide, or zinc oxide.

13. An article comprising:
a first microstructured film comprising a first major surface and an opposing second major surface, wherein the first major surface comprises a plurality of microstructures projecting therefrom, wherein at least some of the plurality of microstructures each has a surface whose slope causes light that is normally incident to the first major surface of the first microstructured film to intercept the first major surface or the surface of at least one other microstructure after reflection;
a release layer disposed on the plurality of microstructures, wherein the release layer comprises a metal layer or a doped semiconductor layer;
a (co)polymer layer disposed on a major surface of the release layer opposite the first microstructured film;
a multilayer optical film disposed on a major surface of the (co)polymer layer opposite the release layer; and
a second microstructured film adjacent to a major surface of the multilayer optical film opposite the (co)polymer layer, wherein the second microstructured film comprises a first major surface and an opposing second major surface, wherein the first major surface comprises a plurality of microstructures projecting therefrom, wherein at least some of the plurality of microstructures each has a surface whose slope causes light that is normally incident to the first major surface of the second microstructured film to intercept the first major surface or the surface of at least one other microstructure after reflection;
wherein the multilayer optical film is comprised of one or more alternating first and second inorganic optical layers collectively reflecting and absorbing light that is normally incident to the first major surface of the second microstructured film, an average of at least 50, 60, 70, 80, 90, or 95 percent of incident ultraviolet light over at least a 30-nanometer wavelength reflection bandwidth in a wavelength range from 190 nanometers (nm) to 400 nm.

14. The article of claim 13, wherein the second microstructured film comprises a cured polysiloxane, a silicone thermoplastic polymer, polyethylene terephthalate (PET), a cured urethane, a thermoplastic urethane, a cured (meth)acrylate, a cured epoxy, a cured vinyl ether, a cured oxetane, a cured thiol-acrylate, a cured thiol-ene, PMMA, coPMMA, a polyimide, a cyclic olefin copolymer, a cyclic olefin polymer, a polycarbonate, a polyethylene naphthalate (PEN), or a fluoropolymer (co)polymer comprising polymerized units derived from one or more monomers selected from tetrafluoroethylene, hexafluoropropylene, vinylidene fluoride, a perfluoroalkoxy alkylene, or a vinyl fluoride, or a combination thereof.

15.-16. (canceled)

17. The article of claim 13, further comprising a tie layer, a substrate, or both disposed on a major surface of the second microstructured film opposite the multilayer optical film.

18. An article comprising:
a microstructured film comprising a first major surface and an opposing second major surface, wherein the first major surface comprises a plurality of microstructures projecting therefrom, wherein at least some of the plurality of microstructures each has a surface whose slope causes light that is normally incident to the first major surface of the microstructured film to intercept the first major surface or the surface of at least one other microstructure after reflection;
a multilayer optical film disposed on the plurality of microstructures, wherein the multilayer optical film is comprised of one or more alternating first and second inorganic optical layers collectively reflecting and absorbing light that is normally incident to the first major surface of the microstructured film, an average of at least 50, 60, 70, 80, 90, or 95 percent of incident ultraviolet light over at least a 30-nanometer wavelength reflection bandwidth in a wavelength range from 190 nanometers (nm) to 400 nm; and
a (co)polymer layer disposed on a major surface of the multilayer optical film opposite the microstructured film.

19. (canceled)

20. The article of claim 18, which transmits light that is normally incident to the first major surface of the second microstructured film, an average of at least 50, 60, 70, 80, 90, or 95 percent of normally incident visible light in a wavelength range from greater than 400 nm to 700 nm.

21. The article of claim 18, wherein an average transmission of wavelengths between 400 nm and 700 nm through the article is reduced by less than 20%, 10%, 5%, or less than 1% after exposure to a dose of 425 megajoules per square meter (MJ/m²) of ultraviolet light.

22. A transfer article comprising:
a microstructured film comprising a first major surface and an opposing second major surface, wherein the first major surface comprises a plurality of microstructures projecting therefrom, wherein at least some of the plurality of microstructures each has a surface whose slope causes light that is normally incident to the first major surface of the microstructured film to intercept the first major surface or the surface of at least one other microstructure after reflection;
a release layer disposed on the plurality of microstructures, wherein the release layer comprises a metal layer or a doped semiconductor layer;
a (co)polymer layer disposed on a major surface of the release layer opposite the microstructured film, wherein the (co)polymer layer optionally further comprises an ultraviolet radiation absorber, a hindered amine light stabilizer, an antioxidant, or a combination thereof.

23. The transfer article of claim 22, wherein the (co)polymer layer is a first (co)polymer layer and wherein the transfer article further comprises a second (co)polymer layer disposed between the microstructured film and the release layer.

24. A method of making an article, the method comprising:
obtaining a transfer article of claim 1;
depositing a polymeric material or a crosslinkable material on an exterior major surface of the transfer article opposite the first microstructured film;
curing the polymeric material or crosslinkable material to form a second microstructured film comprising a first major surface and an opposing second major surface, wherein the first major surface comprises a plurality of microstructures projecting therefrom, wherein at least some of the plurality of microstructures each has a surface whose slope causes light that is normally incident to the first major surface of the second microstructured film to intercept the first major surface or the surface of at least one other microstructure after reflection, and wherein the first major surface of the second microstructured film is adjacent to the multilayer optical film; and
removing the release layer from the transfer article.

25. The method of claim 24, wherein the transfer article is according to claim 1 and the method further comprises removing the first (co)polymer layer after removing the release layer.

26. (canceled)
